(19) United States
(12) Patent Application Publication
(10) Pub. No.: US 2004/0131321 A1
(43) Pub. Date: Jul. 8, 2004

(54) Optical fiber with lens and manufacturing method thereof

(76) Inventors: Toshiya Kubo, Chiba-shi (JP); Hiromitsu Nakayama, Chiba-shi (JP); Norihiro Dejima, Chiba-shi (JP)

Correspondence Address: ADAMS & WILKS, 31st FLOOR, 50 BROADWAY, NEW YORK, NY, 10004, US

(21) Appl. No.: 10/653,641

(22) Filed: Sep. 2, 2003

(30) Foreign Application Priority Data
Sep. 2, 2002 (JP) 2002-256759
Sep. 11, 2002 (JP) 2002-265329
Sep. 1, 2003 (JP) 2003-308925

(51) Int. Cl. G02B 6/18; G02B 6/32

(52) U.S. Cl. 385/124; 385/34

(57) ABSTRACT

An optical fiber with lens for constituting an optical functional component capable of light beam propagation, which improves the stability in holding and handling and contributes to downsizing. To one end of a single mode (SM) optical fiber, which is a main part of the optical fiber with lens, a graded index (GI) optical fiber functioning as a convergence type rod lens and having a predetermined length is integrally connected, and this GI optical fiber is thinner than SM optical fiber. The refractive index distribution constant √A of the GI optical fiber is from 1.0 to 4.0, and the end surface thereof is inclined at from 2.0 degrees to 4.0 degrees. Further, the GI optical fiber may be constituted only by a core part without a clad part.

### BACKGROUND OF THE INVENTION

1. Field of the Invention

The present invention relates to an optical fiber with lens and a manufacturing method thereof.

2. Description of the Related Art

Conventionally, various optical devices are used in an optical communications field etc. In order to couple these optical devices to one another, an optical coupling mechanism in which input side and output side optical fibers are oppositely disposed.

To a conventional optical fiber, generally, a collimator lens for converting a light beam output from the optical fiber into collimated light, or a lens for focusing the light beam is integrally coupled (a lens for diverging the light beam is hardly used). However, since the outer diameters of these lenses are significantly larger than the outer diameter of the optical fiber, there is a disadvantage of upsizing the entire apparatus. Further, the lens having a relatively smaller outer diameter has a disadvantage of larger aberration.

Therefore, in place of these lenses, an optical fiber with lens using a convergence type rod lens formed by a graded index optical fiber (hereinafter, referred to as “GI optical fiber”) is disclosed in the Patent Document 1, for example.

A conventional optical coupling mechanism having such optical fiber with lens includes an input side optical fiber 106 with lens and an output side optical fiber 107 with lens, as shown in FIG. 41. Each of the input side optical fiber 106 with lens and the output side optical fiber 107 with lens include a single mode optical fiber (hereinafter, referred to as “SM optical fiber”) 111 and the GI optical fiber 112 that functions as a lens for converting the light beam entering from these SM optical fiber 111 into collimated light or focused light. The input side optical fiber 106 with lens and the output side optical fiber 107 with lens are disposed so that the GI optical fibers 112 may be opposed and the optical axes thereof may be aligned.

The SM optical fiber 111 has a core part 111a that propagates a light beam and a clad part 111b that surrounds this core part 111a, for example, as shown in FIG. 42. In a typical SM optical fiber 111, the core part 111a is formed so as to have a diameter on the order of 10 μm, and the clad part 111b is formed so as to have an outer diameter on the order of 125 μm.

On the other hand, the GI optical fiber 112 is formed as a convergence type rod lens having a predetermined length, and provided so that the optical axis thereof is aligned with one end of the SM optical fiber 111. As shown in FIG. 43, this GI optical fiber 112 is also constituted by a core part 112a and a clad part 112b, and, for example, when the outer diameter of the clad part 112b is 125 μm, the outer diameter of the core part 112a is generally on the order of 50 μm to 62.5 μm.

The conventional optical coupling mechanism constructed as above, as shown in FIG. 41, in the input side optical fiber 106 with lens, the light beam entering from the SM optical fiber 111 is converted into collimated light or focused light by the GI optical fiber 112, and enters the GI optical fiber 112 of the output side optical fiber 107 with lens.

[Patent Document 1] JP-A-6-138342 (FIGS. 1 to 5)

In the above described conventional optical coupling mechanism, it is required that an error due to displacement is suppressed to improve the accuracy of light propagation by providing a construction capable of efficiently propagating light while suppressing coupling loss of light when performing light propagation with the optical fibers with lens opposed, that is, optimizing the optical fibers with lens, and further, stably holding the optical fibers with lens in precise positions so that the optical axes of the opposed optical fibers may be aligned.

In the GI optical fiber 112 shown in FIG. 43, light progresses within the core part 112a, while the clad part 112b hardly contributes to the light progression. With the same relative refractive index difference Δₙ, the larger the outer diameter of the core part 112a, the less the influence of aberration and the longer the propagation distance of light, and thereby, the larger the core part 112a of the GI optical fiber 112, the better the propagation efficiency.

As is well known, the refractive index of the core part 112a of the GI optical fiber 112 is generally expressed as a function of square of the radius of the core part 112a. Specifically, as shown in FIG. 43(b), assuming that the maximum refractive index of the core part 112a of the GI optical fiber 112 is n₀, the refractive index of apart (clad part 112b) adjacent to the core part 112a is n₁, the relative refractive index difference Δₙ is expressed as the following equation.

$${Δ}_{n} = \frac{{n}_{0}^{2} - {n}_{1}^{2}}{2 {n}_{0}^{2}} \qquad [ Eq . 1 ]$$

Further, the refractive index n(r) in a position where the distance from the center of this core part 112a is r is expressed by the following equation.

n(r)=n₀{1−Δₙ(r/a)^{α}} [Eq. 2]

Note that, in this equation, a is the radius of the core part and α is a multiplier indicating refractive index distribution, and, in the case of the typical GI optical fiber, α=2.

As described above, in the GI optical fibers 112 having the same relative refractive index difference Δₙ between the core part 112a and the clad part 112b, as shown in FIG. 28, the larger the outer diameter of the core part 112a, the longer the distance from the end surface to the beam waist (the position where the beam becomes narrowest), that is, the longer the propagation distance of light becomes. This provides similar effects to those by enlarging the radius of curvature of a ball lens, for example, and the influence of aberration can be reduced.

In the above described conventional example (for example, Patent Document 1), the GI optical fiber 112 that is a convergence type rod lens is smaller than the collimator lens, etc., however, it has a larger diameter than the SM optical fiber 111 that constitutes the main parts of the optical fibers 106 and 107 with lens. That is, these optical fibers 106 and 107 with lens are generally formed with only the tip portions (GI optical fibers 112) thickened, as shown in FIG. 41. There are several problems with these optical fibers 106 and 107 with lens described as below.

Generally, in the case where a long optical fiber is positioned, a construction in which a rectangular groove is formed and the optical fiber is held within the rectangular groove is sometimes adopted. In this case, as shown in FIG. 44(a), the conventional optical fibers 106, 107 with lens with only the tip portion (GI optical fiber 112) thickened have the tip portion bent by the bottom of the rectangular groove 113, and optical coupling with other optical fibers etc. can not be ensured due to inclination of the optical axis. In order to solve this problem, as shown in FIG. 44(b), it is required that the rectangular groove 113 is partially formed deeply corresponding to the tip portion in advance, and the forming operation of the rectangular groove 113 becomes very complicated. By the way, in this construction and the later described respective constructions, a v groove may be provided in place of the rectangular groove.

As shown in FIG. 45, when aligning plural optical fibers 106 and 107 with lens having thick tip portions (GI optical fibers 112) in an array, the pitch p1 should be made larger by the thickness of the tip portions, and thereby the density is difficult to be made higher. In addition, as schematically shown in FIG. 46, for example, in the case where a switching structure is constructed by using the plural optical fibers 106,107 with lens, it is required that the entire optical apparatus is downsized by approximating the opposing distance between the optical fibers 106,107 with lens to the limit, and further, making the r1 smaller. However, the optical fibers 106,107 with lens should be disposed by taking the angle r1 between them larger by the thickness of the tip portions (GI optical fibers 112). As described above, since the tip portions of the optical fibers 106,107 with lens are thick, the entire optical apparatus is upsized.

Even in the case where the optical fibers 106,107 with lens are never accommodated within the rectangular grooves 113, and a plurality of them are never used, when the tip portions (GI optical fibers 112) of the long optical fibers 106,107 with lens are thick and heavy, the barycenter is located near the tip portion, and thereby the stability in holding and handling becomes poor.

Furthermore, in the actual design, in order to accommodate the recent higher integration of optical components, it is preferred that the optical fibers with lens can be aligned with a small pitch with reference to the outer diameter of the optical fibers. For example, it is effective for higher integration that, to the SM optical fiber 111 having an outer diameter of 125 μm, the GI optical fiber 112 having substantially the same outer diameter is connected. Note that the diameter of the core part 112a of the GI optical fiber 112 used for optical communications is on the order of 50 μm to 62.5 μm, and in order not to leak the light from inside of the core for propagating the light over a long distance, the relative refractive index difference Δₙ is large, the influence of aberration is relatively large, the distance from the end surface of the optical fiber with lens to the beam waist is relatively short, and the propagation distance of light is short. Further, since the clad part 112b surrounding the core part 112a of the GI optical fiber 112 becomes a wasted part that does not contribute to the light beam propagation, the construction provides inefficiency.

### SUMMARY OF THE INVENTION

Therefore, the object of the invention is to provide an optical fiber with lens and a manufacturing method thereof for reducing the influence of aberration to make the propagation distance of light longer by enlarging the diameter of a core part of the GI optical fiber, facilitating the holding and the handling of the optical fiber with lens including the GI optical fiber, and constructing an optical coupling mechanism capable of efficient light beam propagation.

A first characteristic of the invention is in that an optical fiber with lens comprises: an optical fiber for propagating light and a graded index optical fiber integrally connected to one end of the optical fiber and having an outer diameter equal to or smaller than an outer diameter of the optical fiber. Thereby, the optical fiber with lens is improved in stability in holding and handling, and contributes to downsizing. The graded index optical fiber may have the outer diameter from 80 μm to 125 μm. Further, the graded index optical fiber may be formed so as to have the outer diameter equal to or smaller than the outer diameter of the optical fiber for propagating light by eliminating at least a part of a clad part thereof by etching.

A second characteristic of the invention is in that an optical fiber with lens comprises: an optical fiber for propagating light and a graded index optical fiber integrally connected to one end of the optical fiber and constituted only by a core part. Thereby, the light beam can be propagated with high efficiency. The graded index optical fiber may have an outer diameter equal to or smaller than an outer diameter of the optical fiber. Further, the graded index optical fiber may have an outer diameter larger than an outer diameter of the optical fiber. The graded index optical fiber may have the outer diameter from 80 μm to 130 μm.

Another characteristic of the invention is in that an optical fiber with lens comprises: an optical fiber for propagating light and a graded index optical fiber integrally connected to one end of the optical fiber and having a refractive index distribution constant √A from 1.0 to 4.0. Thereby, the loss can be prevented from becoming larger due to leakage of the light to the outside, and the loss can be suppressed lower by reducing the influence of aberration, and the error in the length of the graded index optical fiber can be allowed to some degree.

A connecting portion of the graded index optical fiber and the optical fiber may be made thinner than outer diameters of these optical fibers.

It is preferred that an end surface of the graded index optical fiber is inclined from 2.0 degrees to 4.0 degrees relative to a plane orthogonal to an axis direction. Thereby, the return loss can be made larger, and the optical coupling to other members and the arrangement therefor can be prevented from becoming complicated by the inclination of output light.

The optical fiber for propagating light may be a single mode optical fiber.

A functional component of the invention includes an optical fiber with lens having either construction described above.

A manufacturing method of an optical fiber with lens of the invention comprises the steps of: manufacturing a graded index optical fiber constituted only by a core part by fiber-drawing a core part material and integrally connecting the graded index optical fiber constituted only by the core part to one end of a optical fiber for propagating light.

Another manufacturing method of an optical fiber with lens of the invention comprises the steps of: manufacturing a graded index optical fiber constituted only by a core part by etching a graded index optical fiber provided with a clad part surrounding a core part to eliminate the clad part and integrally connecting the graded index optical fiber constituted only by the core part to one end of a optical fiber for propagating light.

Yet another manufacturing method of an optical fiber with lens of the invention comprises the steps of: integrally connecting a graded index optical fiber provided with a clad part surrounding a core part to one end of a optical fiber for propagating light and etching the graded index optical fiber provided with the clad part surrounding the core part to eliminate at least a part of the clad part.

Still another manufacturing method of an optical fiber with lens of the invention comprises the step of integrally connecting a graded index optical fiber having an outer diameter equal to or smaller than an outer diameter of an optical fiber to one end of the optical fiber for propagating light. In this case, the step of at least partially etching the graded index optical fiber before connected so that the graded index optical fiber may have a smaller diameter than the optical fiber may be comprised.

Yet still another manufacturing method of an optical fiber with lens of the invention comprises the steps of: integrally connecting a graded index optical fiber having a diameter equal to or larger than that of an optical fiber to one end of the optical fiber for propagating light and at least partially etching the graded index optical fiber integrally connected to one end of the optical fiber so that the graded index optical fiber may have an outer diameter smaller than an outer diameter the optical fiber.

In the above described manufacturing steps of the optical fiber with lens, a connecting portion of the graded index optical fiber and the optical fiber may be made thinner than outer diameters of these optical fibers.

The optical fiber for propagating light may be a single mode optical fiber.

A manufacturing method of an optical functional component of the invention comprises the step of aligning the optical fibers with lens manufactured by either manufacturing method described above.

### BRIEF DESCRIPTION OF THE DRAWINGS

FIG. 1 is a perspective view showing an optical device including an optical fiber with lens of a first embodiment of the invention.

FIG. 2 is a side view showing a pair of optical fibers with lens of the optical device shown in FIG. 1.

FIG. 3 is an enlarged side view showing the optical fiber with lens shown in FIG. 2.

FIG. 4A is a schematic diagram showing a single mode optical fiber of the optical fiber with lens shown in FIG. 2, and FIG. 4B is a diagram showing the refractive index distribution thereof.

FIG. 5A is a schematic diagram showing a graded index optical fiber of the optical fiber with lens shown in FIG. 2, and FIG. 5B is a diagram showing the refractive index distribution thereof.

FIG. 6 is a graph showing relationship between the end surface angle of the optical fiber with lens and the return loss.

FIG. 7 is a graph showing relationship between the relative refractive index difference of the graded index optical fiber and the diameter of a beam propagation region.

FIG. 8 is a graph showing relationship between a refractive index distribution constant of the graded index optical fiber and a diameter of a beam propagation region.

FIG. 9 is an explanatory diagram showing protruding portions when fusion splicing produced in the optical fiber with lens.

FIG. 10 is an explanatory diagram showing a status in which the protruding portions when fusion splicing are produced in the optical fiber with lens of the first embodiment of the invention.

FIG. 11 is an explanatory diagram showing a status in which the optical fiber with lens of the first embodiment of the invention is disposed within a rectangular groove.

FIG. 12 is an explanatory diagram showing a status in which the optical fibers with lens of the first embodiment of the invention are arranged in an array.

FIG. 13 is an explanatory diagram showing a switching structure constructed by combining the optical fibers with lens of the first embodiment of the invention.

FIG. 14 is a flowchart showing an example of a manufacturing method of the optical fiber with lens of the first embodiment of the invention.

FIG. 15 is a flowchart showing another example of a manufacturing method of the optical fiber with lens of the first embodiment of the invention.

FIG. 16 is a side view showing optical fibers with lens of a second embodiment of the invention.

FIG. 17 is an enlarged side view showing the optical fiber with lens shown in FIG. 16.

FIG. 18A is a schematic diagram showing a graded index optical fiber of the optical fiber with lens shown in FIG. 16, and FIG. 18B is a diagram showing the refractive index distribution thereof.

FIG. 19 is an explanatory diagram showing protruding portions when fusion splicing produced in the optical fiber with lens of the second embodiment of the invention.

FIG. 20A is an explanatory diagram showing a status in which the protruding portions when fusion splicing of the optical fiber with lens of the second embodiment of the invention are eliminated, and FIG. 20B is a diagram showing the refractive index distribution thereof.

FIG. 21A is an explanatory diagram showing the optical fiber with lens of the second embodiment of the invention, the entire diameter of which is made thinner, and FIG. 21B is a diagram showing the refractive index distribution thereof.

FIG. 22A is an explanatory diagram showing the optical fiber with lens of the second embodiment of the invention, the diameter of the graded index optical fiber of which is made thinner, and FIG. 22B is a diagram showing the refractive index distribution thereof.

FIG. 23 is an explanatory diagram showing a manufacturing method of the optical fiber with lens of the second embodiment of the invention.

FIG. 24 is an explanatory diagram showing a manufacturing method of the optical fiber with lens of the second embodiment of the invention.

FIG. 25 is a graph showing the relationship between the etching time and the outer diameter of the optical fiber in the manufacturing method of the optical fiber with lens of the second embodiment of the invention.

FIG. 26 is a flowchart showing an example of a manufacturing method of the optical fiber with lens of the second embodiment of the invention.

FIG. 27 is a flowchart showing another example of a manufacturing method of the optical fiber with lens of the second embodiment of the invention.

FIG. 28 is a graph showing the relationship between the outer diameter of the core part of the graded index optical fiber and the distance from the exit end surface to the beam waist.

FIG. 29A is a schematic plan view showing a first example of an optical fiber array using the optical fiber with lens of the invention, FIG. 29B is a schematic front sectional view thereof, and FIG. 29C is a schematic side view thereof.

FIG. 30A is a schematic plan view showing a first example of an opposed optical fiber collimator using the optical fibers with lens of the invention, and FIG. 30B is a schematic front sectional view thereof.

FIG. 31A is a schematic plan view showing a second example of an optical fiber array using the optical fiber with lens of the invention, FIG. 31B is a schematic front sectional view thereof, and FIG. 31C is a schematic side view thereof.

FIG. 32A is a schematic plan view showing a second example of an opposed optical fiber collimator using the optical fibers with lens of the invention, and FIG. 32B is a schematic front sectional view thereof.

FIG. 33A is a schematic plan view showing a third example of an optical fiber array using the optical fibers with lens of the invention, FIG. 33B is a schematic front sectional view thereof, and FIG. 33C is a schematic side view thereof.

FIG. 34A is a schematic plan view showing a third example of an opposed optical fiber collimator using the optical fibers with lens of the invention, and FIG. 34B is a schematic front sectional view thereof.

FIG. 35 is a schematic plan view for explanation of operation of an optical switch using the optical fibers with lens of the invention.

FIG. 36 is a schematic plan view showing an optical compound module using the optical fibers with lens of the invention.

FIG. 37 is a schematic plan view showing an optical filter and splitter module using the optical fibers with lens of the invention.

FIG. 38 is a schematic plan view showing an optical isolator using the optical fibers with lens of the invention.

FIG. 39 is a schematic plan view showing an optical variable attenuator using the optical fiber with lens of the invention.

FIG. 40 is a schematic plan view showing a light receiving component using the optical fiber with lens of the invention.

FIG. 41 is a side view showing conventional optical fibers with lens.

FIG. 42A is a schematic diagram showing a single mode optical fiber of the optical fiber with lens shown in FIG. 41, and FIG. 42B is a diagram showing the refractive index distribution thereof.

FIG. 43A is a schematic diagram showing a graded index optical fiber of the optical fiber with lens shown in FIG. 41, and FIG. 43B is a diagram showing the refractive index distribution thereof.

FIG. 44 is an explanatory diagram showing a status in which the conventional optical fiber with lens is disposed within a rectangular groove.

FIG. 45 is an explanatory diagram showing a status in which the conventional optical fibers with lens are arranged in an array.

FIG. 46 is an explanatory diagram showing a switching structure constructed by combining the conventional optical fibers with lens.

FIG. 47 is a schematic diagram showing the pitch of a sine curve drawn by a light beam in the graded index optical fiber that has a small refractive index distribution constant √A.

FIG. 48 is a schematic diagram showing the pitch of the sine curve drawn by a light beam in the graded index optical fiber that has a large refractive index distribution constant √A.

FIG. 49 is a graph showing change in the outer diameter of a fusion spliced portion under a fusion splicing condition.

### DETAILED DESCRIPTION OF THE PREFERRED EMBODIMENT

Hereinafter, embodiments of the invention will be described by referring to the drawings.

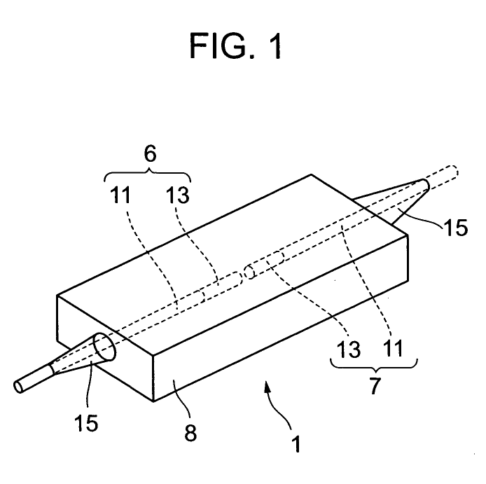

As shown in FIG. 1, an optical coupling mechanism (optical device) 1 of a first embodiment of the invention includes an input side optical fiber 6 with lens and an output side optical fiber 7 with lens, which are optically coupled, and a casing 8 for accommodating a connecting portion of these respective optical fibers 6 and 7 with lens inside thereof.

As shown in FIGS. 1 to 3, each of the optical fibers 6 and 7 with lens includes a single mode optical fiber (hereinafter, referred to as “SM optical fiber”) 11, a graded index optical fiber (hereinafter, referred to as “GI optical fiber”) 13 having a lens function of converting a light beam entering from this SM optical fiber 11 into collimated light or focusing light.

The casing 8 is formed of a rectangular box with a bottom as shown in FIG. 1, and inside thereof, a coupling portion, at which end surfaces “of the respective GI optical fibers 13” of the input side optical fiber 6 with lens and the output side optical fiber 7 with lens are opposed, is sealed in an air tight state. In addition, the respective SM optical fibers 11 of the input side optical fiber 6 with lens and the output side optical fiber 7 with lens are fixed to the casing 8 via sleeves 15.

Since the output side optical fiber 6 with lens has substantially the same construction with the input side optical fiber 7 with lens, the same members are assigned with the same signs and the detailed description thereof will be omitted.

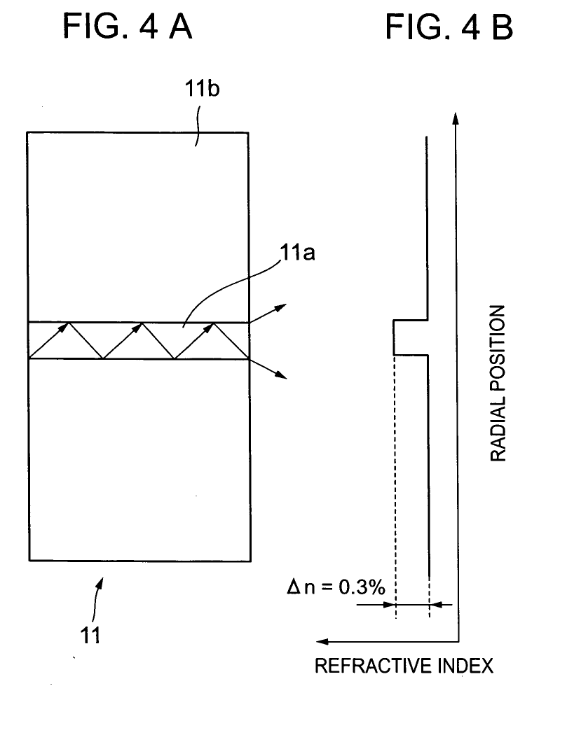

The SM optical fiber 11 of the optical fibers 6 and 7 with lens has a core part 11a that propagates a light beam and a clad part 11b that surrounds this core part 11a, as shown in FIG. 4, and for example, the core part 11a is formed so as to have a diameter on the order of 10 μm, and the clad part 11b is formed so as to have an outer diameter on the order of 125 μm. Then, this SM optical fiber 1 has a numerical aperture NA set on the order of 0.14, and the relative refractive index difference Δₙ between the core part 11a and the clad part 11b set on the order of 0.3%.

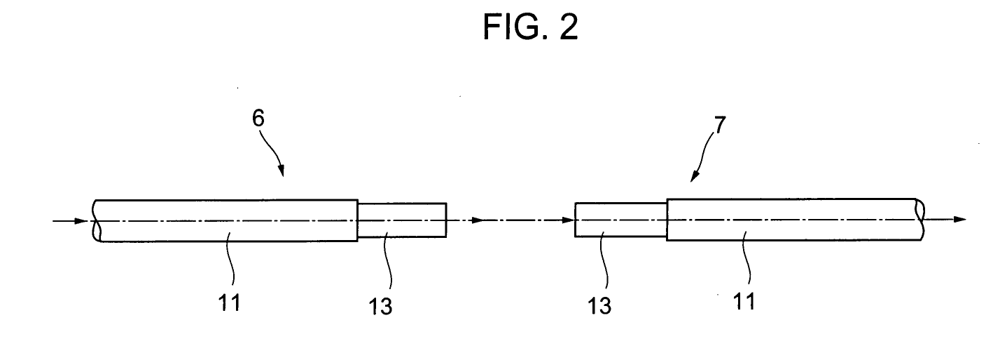

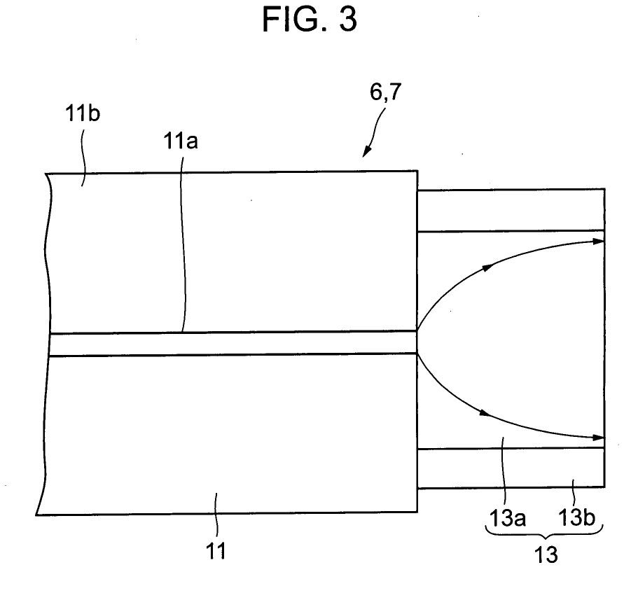

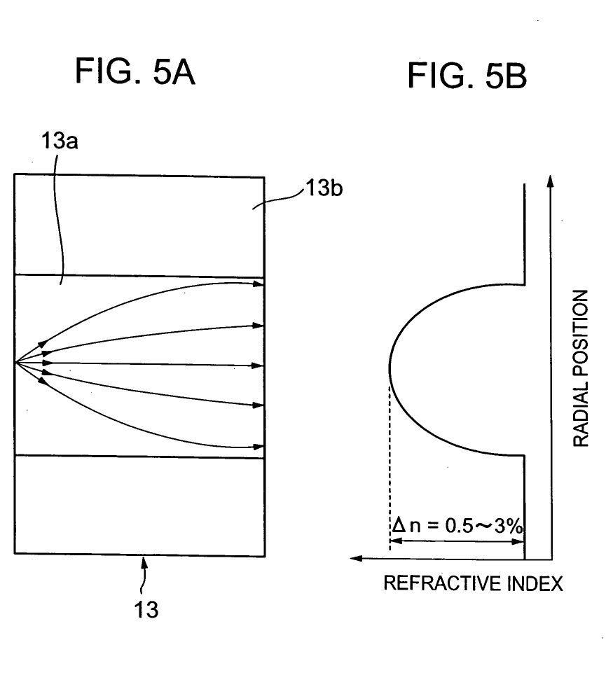

The GI optical fiber 13, which is fusion spliced with one end of the SM optical fiber 11 with the optical axis aligned therewith, is for a light beam entering from the core part 11a of the SM optical fiber 11, and as shown in FIGS. 2 and 3, it has a smaller diameter than the outer diameter of the SM optical fiber 11. As an example, in this GI optical fiber 13, an outer diameter of the core part 13a is on the order of 50 μm to 62.5 μm, and an outer diameter of the clad part 13b is on the order of 100 μm, as shown in FIG. 5(a). Formed in a predetermined length along the optical axis, the construction functions as a so-called convergence type rod lens. The refractive index distribution of the GI optical fiber 13 is in the form of a curve having a maximum on the optical axis, as shown in FIG. 5(b), and the light beam entering from the core part 11a of the SM optical fiber 11 is converted into collimated light.

Further, it is preferred that the GI optical fiber 13 has an end surface, which is opposite to the GI optical fiber 13 of the other optical fiber with lens, formed so that it may be inclined at a predetermined inclination angle (preferably from 2 to 4 degrees) relative to a plane orthogonal to the optical axis. The GI optical fiber 13 can suppress the so-called return loss generated by the reflected light, which is the light beam reflected on this end surface in the direction of the optical axis, due to inclination of the end surface. That is, the reflected light reflected on the inclined surface that is formed on the end surface of the GI optical fiber 13 is reflected in a direction inclined relative to the direction of the optical axis, and thereby it leaks to the outside of the core part without affecting the propagated light beam.

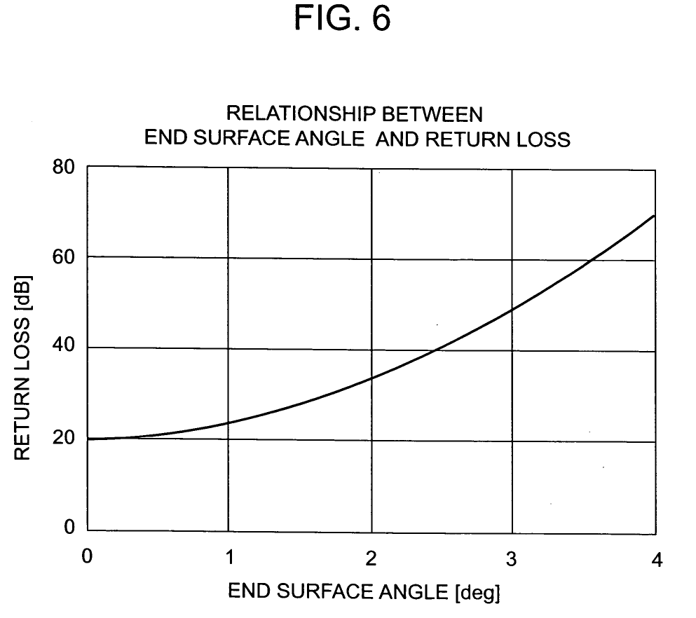

FIG. 6 shows the relationship between the end surface angle of the GI optical fiber 13 and the return loss. In order to improve the return loss, the end surface angle is preferably made larger, and, for example, the end surface angle is preferably equal to or more than 2 degrees for achieving the return loss of equal to or more than 30 dB, however, it is not preferable that the end surface angle is too much larger because the inclination of the output light becomes larger and the optical coupling to other members and the arrangement therefor become complicated. Therefore, the end surface angle is suitably set substantially from 2 degrees to 4 degrees. By the way, in the case of inclining the end surface of the GI optical fiber 13, the working cost can be suppressed by forming the inclined surface by cutting, for example.

Further, the end surface of the GI optical fiber 13 may have the inclined surface applied with anti-reflection coating as necessary, and thereby the return loss and the insertion loss of the entire optical device 1 can be reduced.

In the optical device 1 constructed as above, the status of the light beam propagated by the optical fibers 6 and 7 with lens will be described by referring to FIGS. 2 and 3.

First, in the input side optical fiber 6 with lens, the light beam propagated through the core part 1a of the SM optical fiber 11 enters the core part 13a of the GI optical fiber 13. At this time, the light beam output from the core part 11a of the SM optical fiber 11 has an exit angle dependent on the NA (numerical aperture) of the SM optical fiber, NA=n₀ sin θ (no is refractive index of the core part 11a), enters the core part 13a of the GI optical fiber 13, which has a larger diameter than the diameter of the core part 11a of the SM optical fiber 11, is reflected according to the refractive index distribution of the core part 13a, gradually converted into collimated light, and output. FIG. 3 shows a propagation region of this light beam by lines with arrows. Then, the collimated light beam output from the input side optical fiber 6 with lens and propagating through space enters the core part 13a of the GI optical fiber 13 of the output side optical fiber 7 with lens. Subsequently, having focused within the GI optical fiber 13, the beam enters the core part 11a of the SM optical fiber 11 and propagates within the core part 11a.

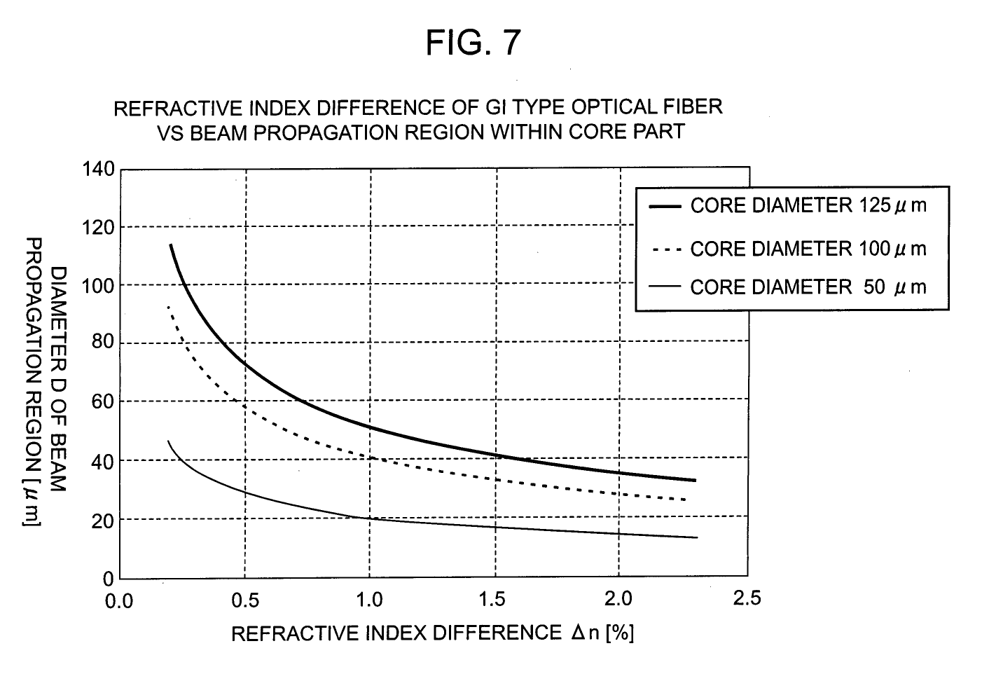

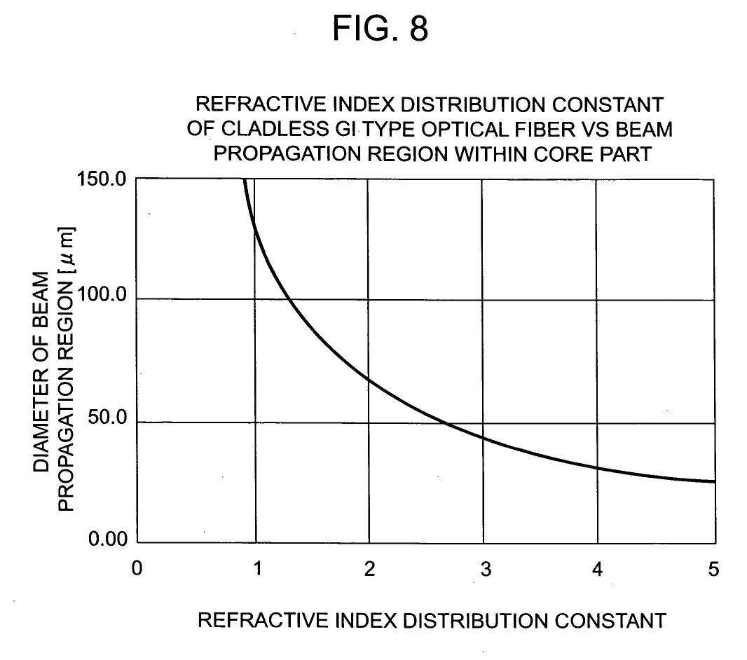

Note that, in fact, there are some regions that do not contribute to the propagation of the collimated light beam even in the core part of the GI optical fiber. FIGS. 7 and 8 show the relationships between the relative refractive index difference Δₙ, the refractive index distribution constant √A, and the diameter D of the light beam propagation region. The light beam propagation region of a GI optical fiber for optical communication is generally defined by 1/e², however, since the optical fiber is used as a lens at this time, the diameter D of the light beam propagation region is defined as 1/e⁸. From FIGS. 7 and 8, it is seen that the smaller the relative refractive index difference Δₙ and the refractive index distribution constant √A, the larger the diameter D of the light beam propagation region of the GI optical fiber.

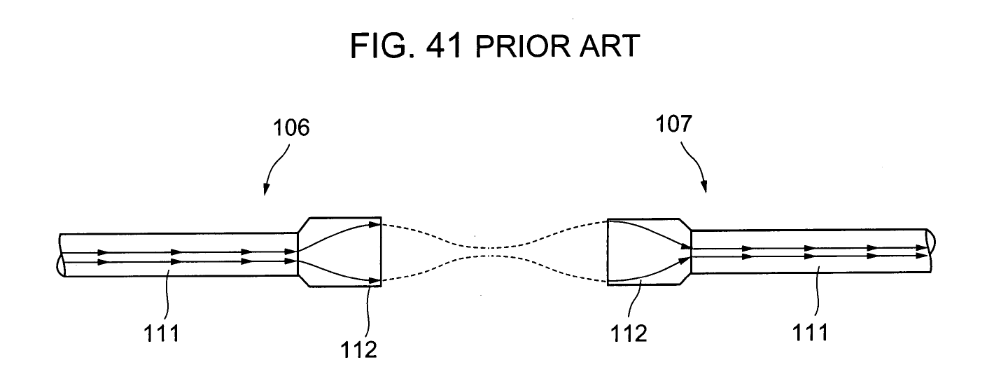

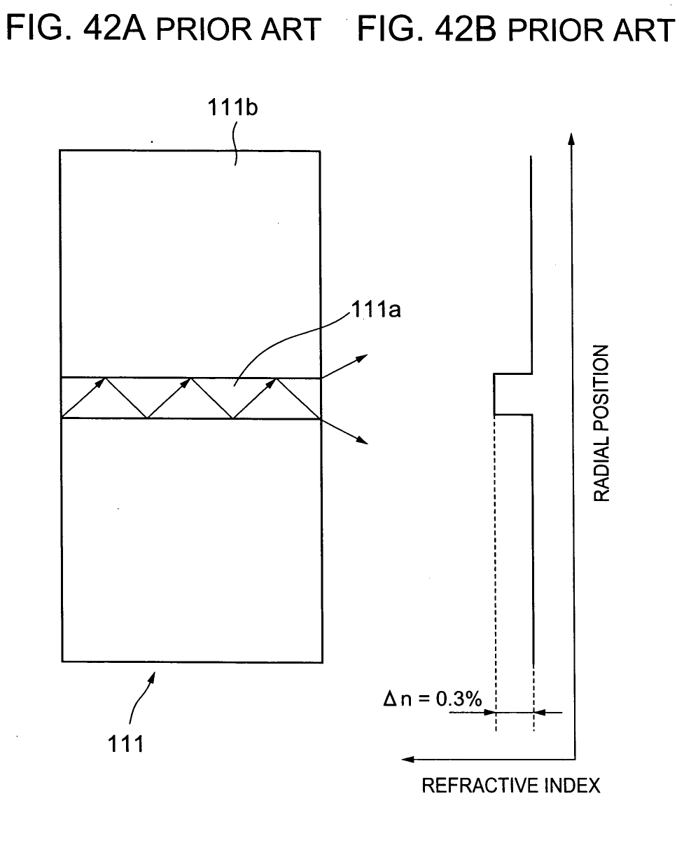

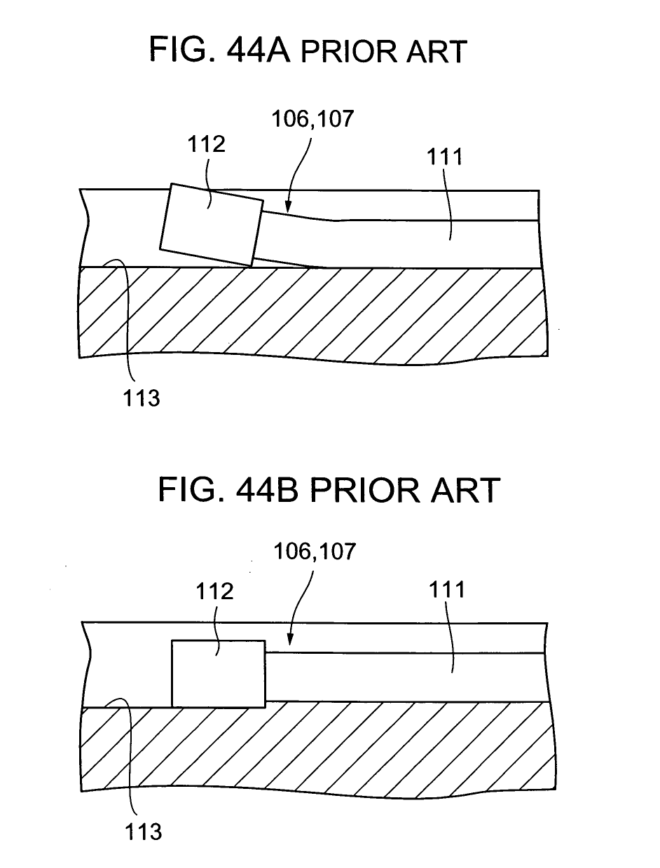

Next, the thickness of the GI optical fibers 13 and SM optical fibers 11 of the optical fibers 6 and 7 with lens will be described. As conventional examples (for example Patent Document 1) shown in FIGS. 41 and 44 to 46, in the case where the GI optical fiber 112 has a larger diameter than the SM optical fiber 111, there are drawbacks in that an extremely complicated forming operation on rectangular grooves 113 is required to accommodate these optical fibers 106 and 107 with lens within the rectangular grooves, the upsizing of the entire optical apparatus may occur due to difficulty in making the density higher, and thereby the stability in holding and handling becomes worse.

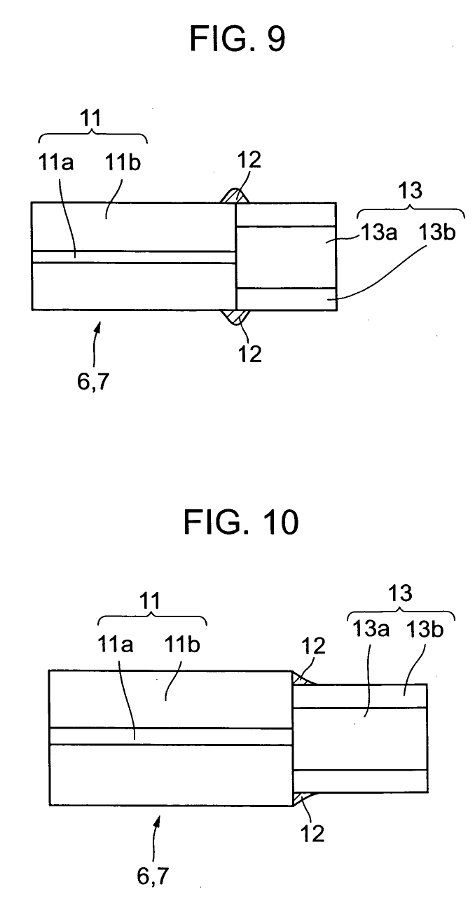

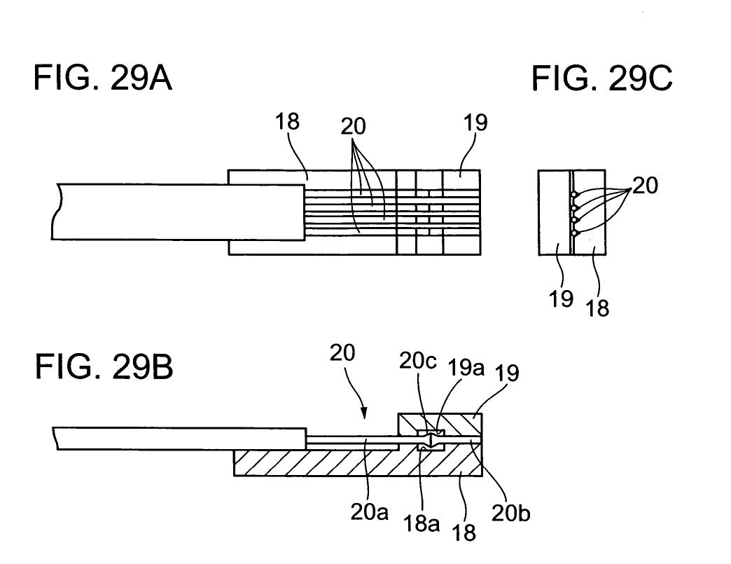

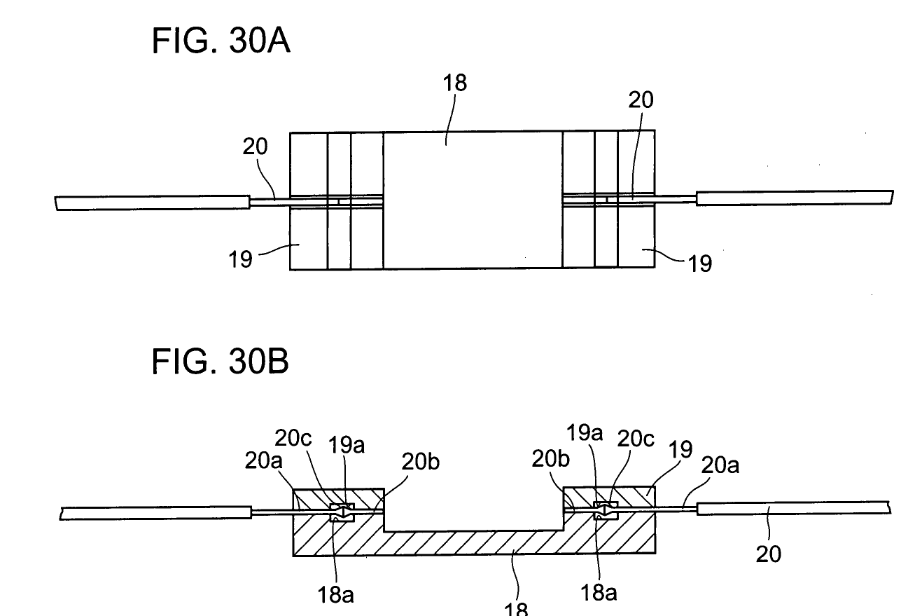

Further, in the case of the construction in which the GI optical fiber 13 and the SM optical fiber 11 having the same diameter are fusion spliced, as shown in FIG. 9, it is possible that protruding portions 12 when fusion splicing protrude and become thick on the periphery of the fusion spliced portion of the GI optical fiber 13 and the SM optical fiber 11. In this case, the problem that, when disposing it in the rectangular groove, etc., for example, it can not be stably disposed by being hindered by the protruding portion 12, and the optical axes of the optical fibers 6 and 7 with lens become displaced from the predetermined position arises. On this account, it is conceivable that recesses for accommodating the thickened protruding portions 12 when fusion splicing are provided in the fixing member, as shown in FIGS. 29 and 30, or after fusion splicing of the GI optical fiber 13 and the SM optical fiber 11, etching treatment is performed for eliminating the thickened protruding portions 12 when fusion splicing.

On the contrary, in the embodiment, in contrast to the conventional example (for example, JP-A-6-138342) as described above, the GI optical fiber 13 that is a tip portion of the optical fibers 6,7 with lens has a smaller diameter than the SM optical fiber 11 that constitutes the main part of the optical fibers 6,7 with lens. In the case of such construction, as shown in FIG. 10, even when the protruding portions 12 when fusion splicing become thick to some degree, they do not protrude to the outer side than the periphery of the SM optical fiber 11, thereby the steps of forming recesses or etching are not required and the stable disposition can be performed.

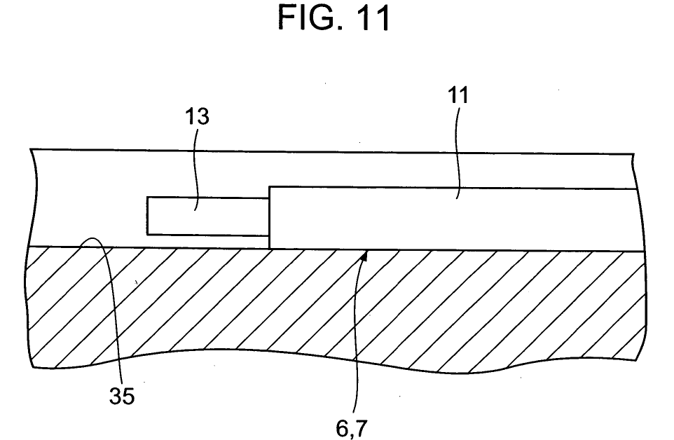

Therefore, in the case where the optical fibers 6 and 7 with lens in the embodiment are accommodated within the rectangular grooves 35, as shown in FIG. 11, since the SM optical fibers 11 that are the main parts of these optical fibers 6 and 7 with lens are stably disposed within the rectangular grooves 35, the fibers are stably held without positional errors even when the GI optical fibers 13 float within the rectangular grooves 35 to some degree. The complicated operation for working the rectangular groove 35 into a complicated form is not required. By the way, in this construction and the respective constructions described below, a V groove may be provided in place of the rectangular groove.

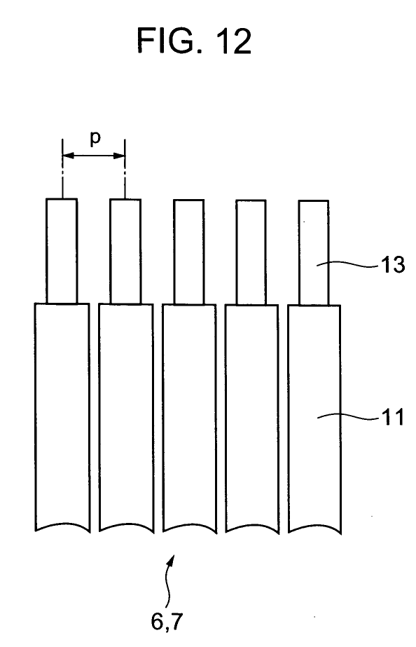

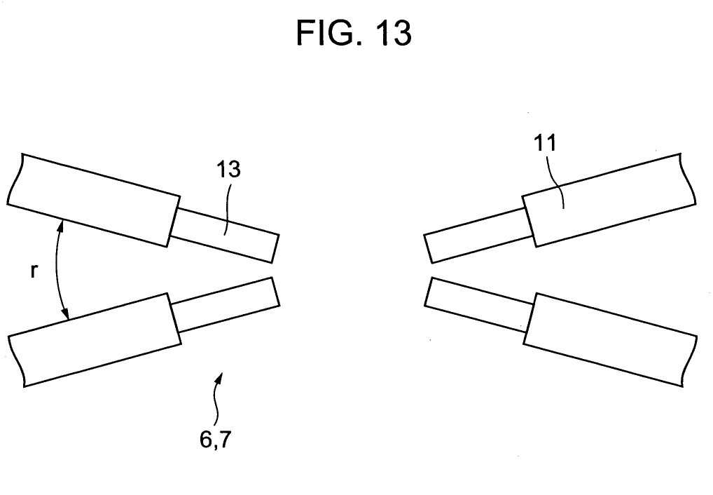

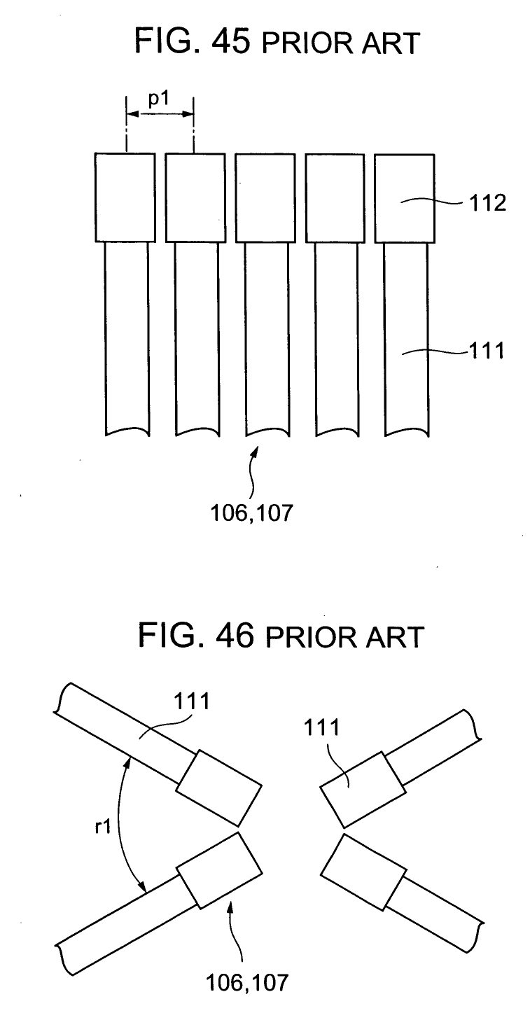

Further, when aligning a plurality of the optical fibers 6 and 7 with lens in an array, as shown FIG. 12, high density arrangement can be performed according to the size of the thin tip portion (GI optical fiber 13). The pitch p can be made smaller than the pitch p1 in the conventional example shown in FIG. 45. Depending on the circumstances, the fibers can be arranged with the pitch equal to or smaller than the pitch of the main part (SM optical fiber 11). Furthermore, as schematically shown in FIG. 13, for example, in the case where the switching structure using plural optical fibers 6 and 7 with lens is constructed, the angle r between the optical fibers 6 and 7 with lens can be made smaller than the angle r1 in the conventional example shown in FIG. 46, and thereby the accuracy can be improved by suppressing the angle declination to contribute to the downsizing of the entire optical apparatus.

Moreover, since the optical fibers 6,7 with lens in the embodiment have thin and light tip portion (GI optical fiber 13) and the barycenter is located in the rearward main part (SM optical fiber 11), they can be very stably held, easy to be handled, and besides, hardly affected by the external vibration.

Next, a manufacturing method of the optical fibers 6 and 7 with lens in the embodiment will be briefly described. The optical fibers 6 and 7 with lens shown in FIGS. 2 and 3 can be manufactured by integrally connecting the GI optical fiber 13 that originally has a smaller diameter than the SM optical fiber 11 to the end of the SM optical fiber 11 by fusion splicing, etc., or, can be manufactured, after integrally connecting the GI optical fiber 13 that originally has an equal diameter to or a larger diameter to the end of the SM optical fiber by fusion splicing, etc., by etching the clad part 13b of the GI optical fiber 13 to have a smaller diameter with etching solution such as hydrofluoric acid. In either case, the GI optical fiber 13 is cut into the predetermined length so as to function as a convergence type rod lens having a desired property.

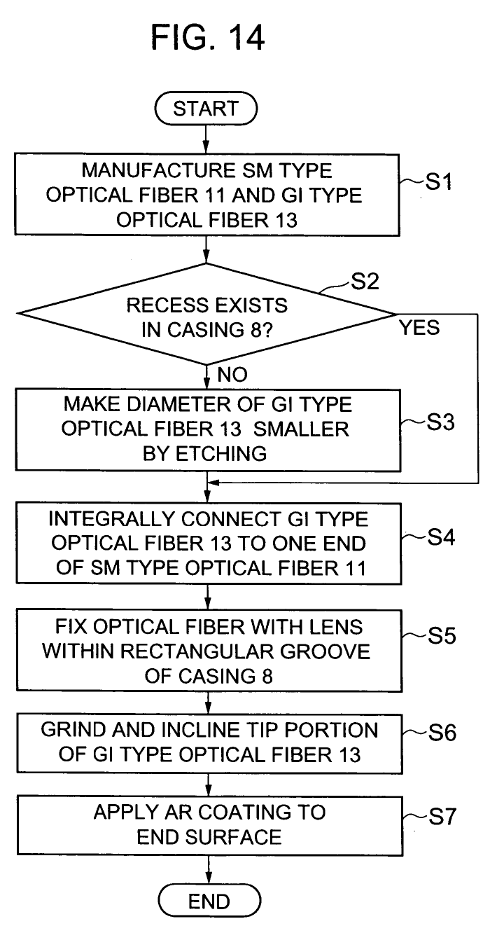

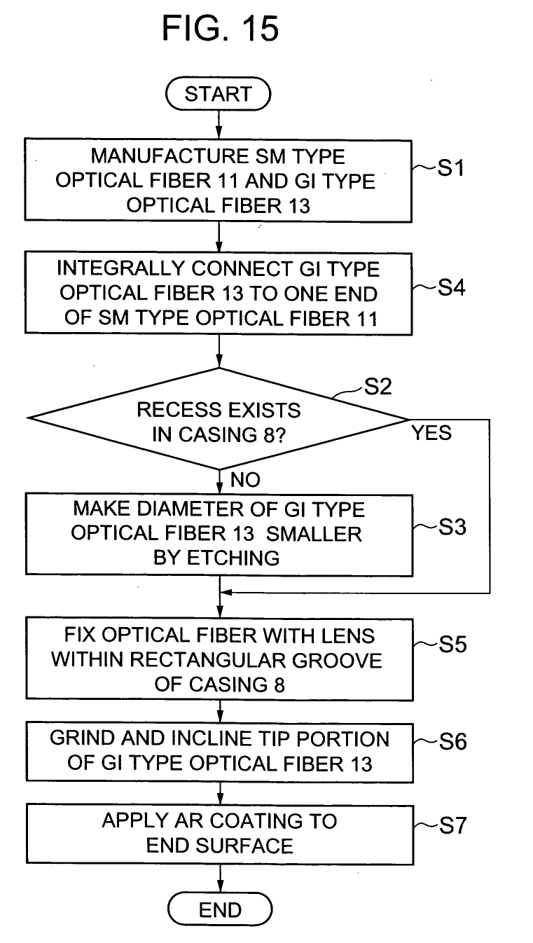

FIGS. 14 and 15 show flowcharts showing actual manufacturing methods. In the manufacturing method shown in FIG. 14, first, the SM optical fiber 11 and the GI optical fiber 13 are respectively manufactured (step S1). Then, the form of the casing 8 for fixing the optical fibers 6 and 7 with lens is checked. That is, in the example shown in FIG. 14, whether the recess for providing clearance for the fusion spliced portion 12 exists in the casing 8 is checked (step S2), and in the case where the recess does not exist, etching is performed so that the GI optical fiber 13 may have a smaller diameter than the SM optical fiber 11 (step S3), as shown in FIGS. 2 and 3. Assuming the case where the recess for providing clearance for the protruding portion 12 when fusion splicing exists in the casing 8, since the thick protruding portion can be accommodated within the recess as shown in FIGS. 29 and 30 and described later, the diameter of the GI optical fiber 13 is not necessarily made smaller by etching. Then, GI optical fiber 13 is integrally connected to one end of the SM optical fiber 11 (step S4). Thus, nearly completed optical fibers 6 and 7 with lens are fixed within the rectangular groove, which is not shown, of the casing 8 (step S5), and then, the tip portions of the optional fibers 6 and 7 with lens, i.e., the tip portions of the GI optical fibers 13 are grinded to be inclined (step S6), and anti-reflection coating (AR coating) is applied to the end surface (step S7). By the way, since the end surface of the lens type optical fiber that has been grinded or cut to be inclined and applied with anti-reflection coating in advance may be fixed within the rectangular groove, the steps S5, S6, and S7 may not be necessarily operated in such sequence.

On the other hand, in the manufacturing method shown in FIG. 15, the SM optical fiber 11 and the GI optical fiber 13 are respectively manufactured (step S1), and then, the GI optical fiber 13 is integrally connected to one end of the SM optical fiber 11 (step S4). Subsequently, whether the recess exists in the casing 8 for fixing the optical fibers 6 and 7 with lens is checked (step S2), and in the case where the recess does not exist, etching is performed so that the GI optical fiber 13 may have a smaller diameter than the SM optical fiber 11 (step S3), as shown in FIGS. 2 and 3. In this case, it is possible that the diameter of the SM optical fiber 11 is also slightly etched and made smaller in the fusion spliced portion. In the case where the recess for providing clearance for the protruding portion 12 exists in the casing 8, the diameter of the GI optical fiber 13 is not necessarily made smaller by etching. Thus, nearly completed optical fibers 6 and 7 with lens are fixed within the rectangular groove, which is not shown, of the casing 8 (step S5), and then, the tip portion of the GI optical fiber 13 is grinded to be inclined (step S6), and anti-reflection coating (AR coating) is applied to the end surface thereof (step S7). By the way, since the end surface of the lens type optical fiber that has been grinded or cut to be inclined and applied with anti-reflection coating in advance may be fixed within the rectangular groove, the steps S5, S6, and S7 may not be necessarily operated in such sequence.

Note that, as methods for integrally connecting the SM optical fiber 11 and GI optical fiber 13, a method by fusion splicing and a method by using an adhesive agent are conceivable. In the case of the optical fiber with quartz as a main component, fusion splicing is effective, while, in the case of the optical fiber with synthetic resin as a main component, bonding is effective, and specifically, preferable by using an ultraviolet curing adhesive agent (UV adhesive agent) including a refractive index matching agent.

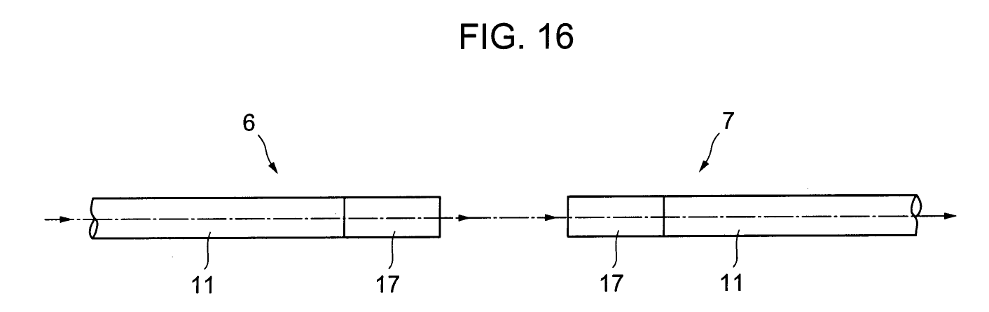

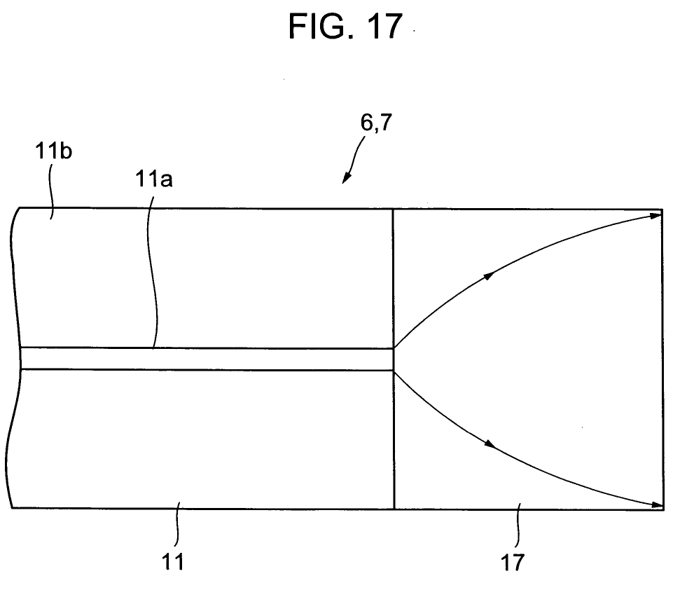

Next, a second embodiment of the invention will be described. The components same as those in the first embodiment will be assigned with the same signs and the description thereof will be omitted. The basic construction of the optical fibers 6 and 7 with lens in the embodiment shown in FIGS. 16 and 17 is substantially the same with that in the first embodiment shown in FIG. 1 except for a GI optical fiber 17.

An SM optical fiber 11 of the optical fibers 6 and 7 with lens in the embodiment has substantially the same construction as that shown in FIG. 4, and it has a core part 11a that propagates a light beam and a clad part 11b that surrounds this core part 11a, and for example, the core part 11a is formed so as to have a diameter on the order of 10 μm, and the clad part 11b is formed so as to have an outer diameter on the order of 125 μm. This SM optical fiber 11 has a numerical aperture NA set on the order of 0.14, and the relative refractive index difference Δₙ between the core part 11a and the clad part 11b set on the order of 0.3%.

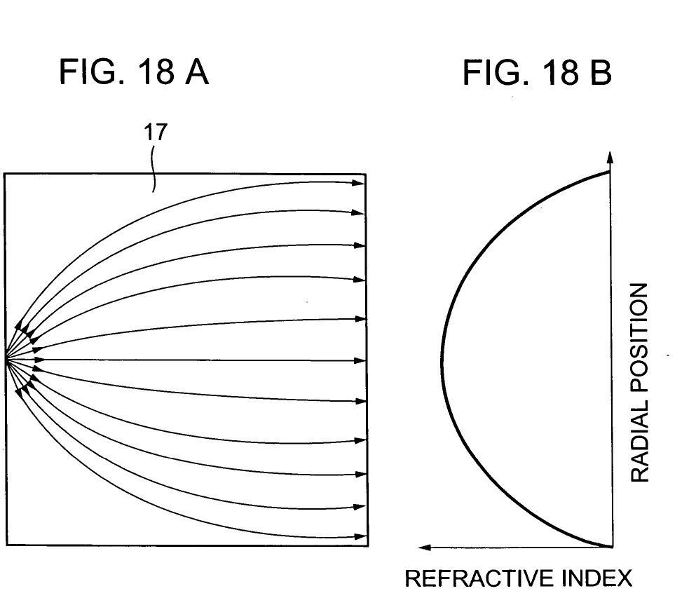

On the other hand, the GI optical fiber 17 that is fusion spliced with one end of the SM optical fiber 11 with the optical axis aligned therewith is for a light beam entering from the core part 11a of the SM optical fiber 11, and as shown in FIGS. 16 to 18, it is constituted only by a core part that has a diameter equal to or smaller than the outer diameter (125 μm) of the SM optical fiber 11, and has no clad part. Formed in a predetermined length along the optical axis, the construction functions as a so-called convergence type rod lens. The refractive index distribution of the GI optical fiber 17 is in the form of a curve having a maximum on the optical axis, as shown in FIG. 18(b), and the light beam entering from the core part 11a of the SM optical fiber 11 is converted into collimated light.

The conventional optical fiber as used in the first embodiment has the construction in which the core part is surrounded by the clad part. The light beam progresses within the core part, and when the light beam contacts the boundary face from the core part to the clad part, most of the light beam is reflected according to the relative refractive index difference and returned into the core part, and as a result, the light beam propagates within the core part (see FIG. 4). Basically, the GI optical fiber 13 in the first embodiment also adopts such construction as shown in FIG. 5, and there is the clad part 13b surrounding the core part 13a. However, in the case of the GI optical fiber 13, since it has the refractive index distribution as shown in FIG. 5(b) in its cross section, as and when the length of the GI optical fiber 13 is appropriately set, the light output from the core part 13a progresses as a substantially collimated light beam. That is, since there are very few light beams to go out of the core part 13a, the clad part 13b that serves to return the light beam into the core part by the reflection according to the relative refractive index difference is not required. Therefore, in the embodiment, as shown in FIG. 18, the GI optical fiber 17 that has no clad part and is constituted only by the core part is manufactured and used.

Conventionally, in the GI optical fiber 112 having an outer diameter of 125 μm, the beam propagation region is only the core part 112a having an outer diameter on the order of 50 to 62.5 μm, however, in the GI optical fiber 17 of the invention, the optical fiber having an outer diameter of 125 μm as a whole becomes the beam propagation region that converts the propagating light into a collimated light beam. Therefore, by eliminating the clad part of the GI optical fiber, which is conventionally almost no use, almost entire of the GI optical fiber can be utilized as the beam propagation region, and thereby the diameter of the light beam propagation path can be enlarged to the outer diameter of the optical fiber, the length capable of propagation becomes longer by the influence of the aberration, and the propagation efficiency can be improved.

In the case where such GI optical fiber 17 having no clad part is fixed to a rectangular groove etc., even when the peripheral part is fixedly bonded by an adhesive agent having high refractive index, the light never leaks to the outside.

Further, in the embodiment as well as in the first embodiment, it is preferred that the GI optical fiber 17 has an end surface, which is opposite to the GI optical fiber 17 of the other optical fiber with lens, formed so that it may be inclined at a predetermined inclined angle (preferably from 2 degrees to 4 degrees) relative to a plane orthogonal to the optical axis. Further, when this inclined surface is applied with anti-reflection coating, the reflection loss and the insertion loss of the entire optical device 1 can be reduced.

In the optical device of the embodiment, the status of the light beam that is propagated by the optical fibers 6 and 7 with lens will be described.

First, in the input side optical fiber 6 with lens, the light beam propagated through the core part 11a of the SM optical fiber 11 enters the GI optical fiber 17. At this time, the light beam output from the core part 11a of the SM optical fiber 11 has an exit angle-dependent on the NA (numerical aperture) of the SM optical fiber, NA=n₀ sin θ (n₀ is refractive index of the core part 11a), enters the core part 13a of the GI optical fiber 13 that has a larger diameter than the diameter of the core part 11a of the SM optical fiber 11, is reflected according to the refractive index distribution of the core part 13a, gradually converted into collimated light, and output. FIG. 17 shows a propagation region of this light beam by lines with arrows. Then, the collimated light beam output from the input side optical fiber 6 with lens and propagating through space enters the GI optical fiber 17 of the output side optical fiber 7 with lens. Subsequently, having focused within the GI optical fiber 17, the beam enters the core part 11a of the SM optical fiber 11 and propagates within the core part 11a.

According to the optical fibers 6 and 7 with lens having the GI optical fiber 17 in the embodiment, since almost entire of the GI optical fiber can be utilized as the beam propagation region, the diameter of the light beam propagation path can be enlarged to the outer diameter of the optical fiber, the length capable of propagation becomes longer by the influence of the aberration, and the propagation efficiency can be improved.

Note that, in fact, there are some regions that do not contribute to the propagation of the light beam even in the GI optical fiber 17 constituted only by the core part. As described above, FIGS. 6 and 7 show the relationships between the relative refractive index difference Δₙ, the refractive index distribution constant √A, and the diameter D of the light beam propagation region, of the core part of the GI optical fiber and it is seen that the smaller the relative refractive index difference Δₙ and the refractive index distribution constant √A, the more effectively the core part of the GI optical fiber can be used.

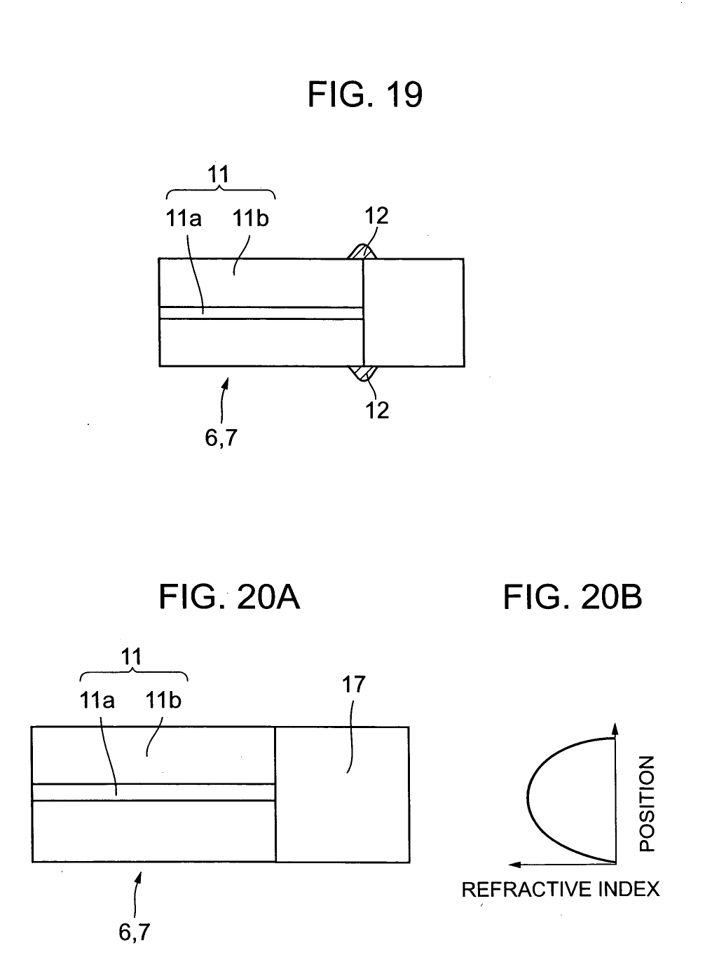

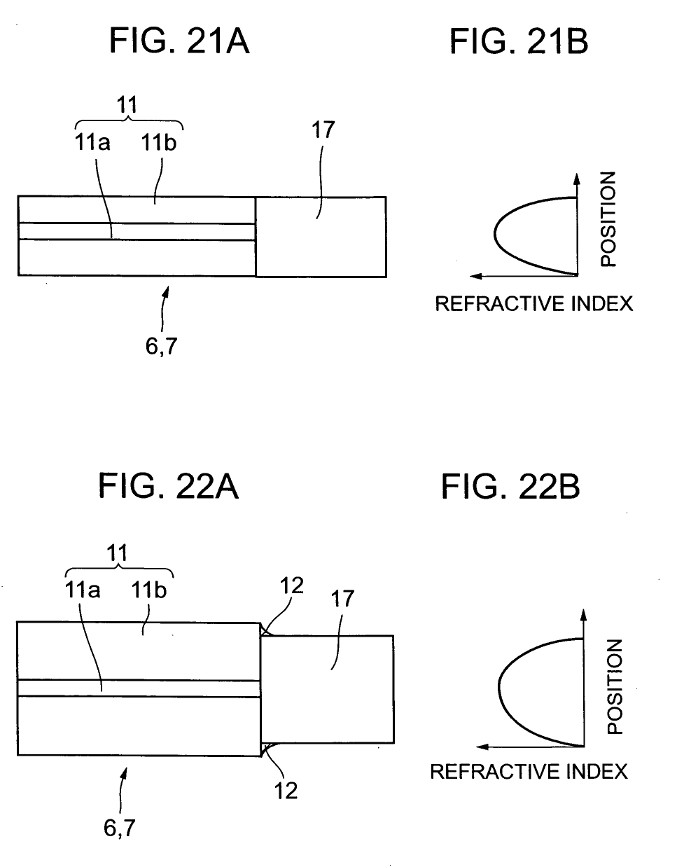

Next, the thickness of the GI optical fiber 17 and SM optical fiber 11 in the optical fibers 6 and 7 with lens will be described. In the case of the construction in which the GI optical fiber 17 and the SM optical fiber 11 having the same diameter are integrally connected, as is the case with that shown in FIG. 9, it is possible that protruding portions 12 when fusion splicing protrude and become thick as shown in FIG. 19. In this case, the problem that, when disposing it in the rectangular groove, etc., for example, it can not be stably disposed by being hindered by the protruding portion 12 to protrude outside, and the optical axes of the optical fibers 6 and 7 with lens become displaced from the predetermined positions arises. Therefore, etching treatment is performed after fusion splicing of the GI optical fiber 17 and the SM optical fiber 11 to eliminate the thickened protruding portion 12, and good optical fibers 6 and 7 with lens having flat and smooth peripheral surfaces can be obtained as shown in FIG. 20. In this case, only the thickened protruding portion 12 may be eliminated, however, in the case where the existing GI optical fiber 112 is used as described above, the protruding portion 12 may be eliminated at the same time with the clad part 112b of the GI optical fiber 112. Furthermore, not only by eliminating the thickened protruding portion 12 but also by uniformly cutting of f the peripheral portion of the GI optical fiber 17 and the peripheral portion of the SM optical fiber 11, the optical fibers 6 and 7 with lens can be made thinner as a whole as shown in FIG. 21. By such method, the optical fibers 6 and 7 with lens that are thinner than the existing standard product, and specifically suitable for arraying for high density packaging.

Moreover, in order not to allow the protruding portion 12 to protrude to the outside, as shown in FIG. 22, as well as in the first embodiment, the construction in which, to the SM optical fiber 11, the thinner GI optical fiber 17 is joined may be provided. In this case, the thickness of the GI optical fiber 17 is set so as not to protrude outerside than the periphery of the SM optical fiber 11 even when the protruding portion 12 becomes thick to some degree. By this method, the etching is not required. Generally, since the GI optical fiber 17 is extremely shorter than the entire length of the SM optical fiber 11, the stable arrangement of the optical fibers 6 and 7 with lens is left unhindered when this GI optical fiber 17 is slightly thinner. On the contrary, it is assumed that the SM optical fiber 11 is thinner than the GI optical fiber 17, when disposed in the rectangular groove, for example, the SM optical fiber 11 that constitutes the major part of the optical fibers 6 and 7 with lens floats from the rectangular groove and becomes unstable.

Next, a manufacturing method of the GI optical fibers 13 and 17 in the first and second embodiments and the optical fibers 6 and 7 with lens will be described.

As the manufacturing method of the GI optical fiber 13 shown in FIG. 5 and the GI optical fiber 17 shown in FIG. 18, two different manufacturing methods are conceivable. The first method is the method for manufacturing by adjusting the content distribution of germanium (or fluorine) so that the core member of silica formed by the VAD method (Vapor phase Axial Deposition Method), PCVD method (Plasma Chemical Vapor Deposition Method), or MCVD method (Modified Chemical Vapor Deposition Method), in which germanium (or fluorine) is appropriately contained, may have refractive index distribution as shown in FIG. 18(b), and drawing. Note that germanium is for increasing refractive index, while fluorine is for reducing refractive index. In order to precisely approximate the refractive index at the center of the GI optical fiber to the theoretical equation as close as possible without reducing it, and further, in order to precisely approximate the refractive index characteristics of the GI optical fiber 17 to the function in proximity to the square of the theoretical radius of the core part as Eq. 2, it is preferred to use the VAD method or PCVD method.

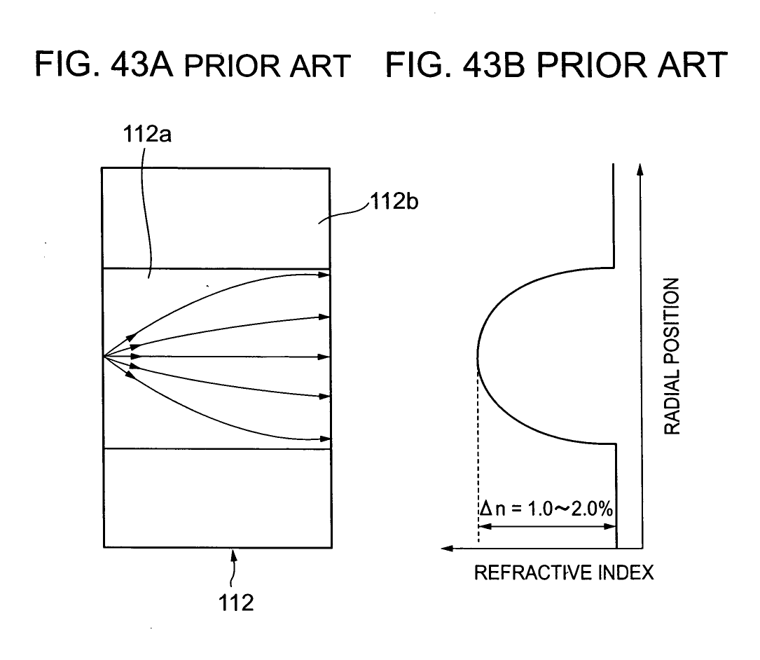

The second method for manufacturing the GI optical fiber 17 is the method for obtaining the GI optical fiber 17 having no clad part but the core part only as shown in FIG. 18 by etching the conventional GI optical fiber 112 constituted by the core part 112a and the clad part 112b as shown in FIG. 43 with etching solution such as hydrofluoric acid to eliminate the clad part 112b.

The first method has advantages that the manufacture is performed without waste materials and the production efficiency is good, while the second method has advantages that existing commercial products etc. can be used as materials and the production efficiency can be improved because the GI optical fiber 17 of the invention can be manufactured by utilizing the conventional GI optical fiber 112.

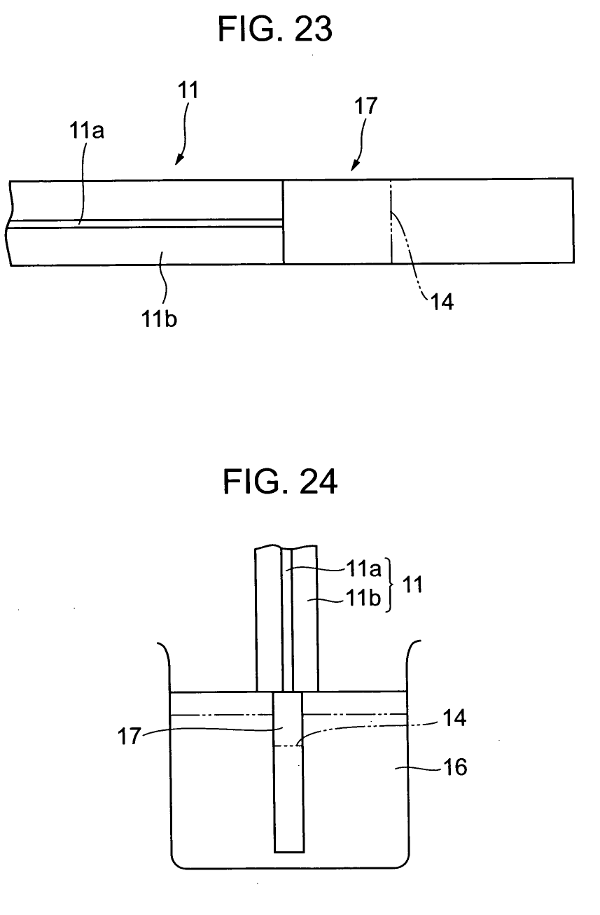

In addition, as the manufacturing method of the optical fibers 6 and 7 with lens in which thus manufactured GI optical fiber 17 is connected to the SM optical fiber 11, there is the method for integrally connecting the GI optical fiber 17 manufactured by either method described above to the SM optical fiber 11 by fusion or bonding as shown in FIG. 23. Then, the GI optical fiber 17 is cut into the predetermined length along the cutting line 14 so as to function as a convergence type rod lens having a desired property.

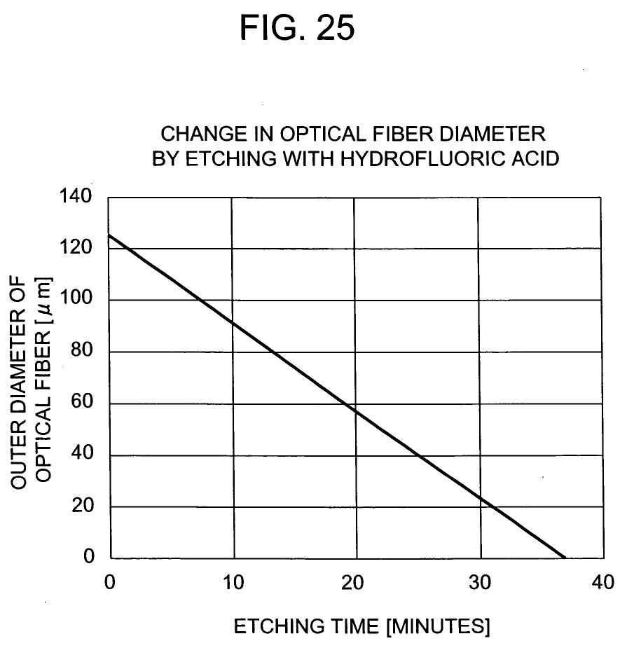

On the other hand, as another manufacturing method of optical fibers 6 and 7 with lens of the invention, there is the method for obtaining the optical fibers 6 and 7 with lens including the GI optical fiber 17 having no clad part but core part only as shown in FIG. 18 by integrally connecting the conventional GI optical fiber 112 constituted by the core part 112a and the clad part 112b as described above, as shown in FIG. 43, to the SM optical fiber 11 by fusion or bonding, and then, etching with the etching solution 16 such as hydrofluoric acid to eliminate the clad part 112b. The etching solution 16 may have double-layer structure of 40% to 50% hydrofluoric acid and organic solvent that does not react to hydrofluoric acid and has a lower specific gravity than hydrofluoric acid, which is added for preventing hydrofluoric acid from evaporation. FIG. 24 shows the boundary of the hydrofluoric acid layer and the organic solvent layer by a chain double-dashed line. Further, FIG. 25 shows the relationship between the treatment time (etching time) and the outer diameter of the optical fiber in the case where etching is performed on the optical fibers 6 and 7 with lens in outer diameter of 125 μm. After thus etching treatment is performed, the GI optical fiber 17 is cut into the predetermined length along the cutting line 14 so as to function as a convergence type rod lens having a desired property.

Furthermore, when fusing splicing the SM optical fiber and the GI optical fiber, by adjusting the amount of discharge and tension of the fusion splicing machine, the portion neighboring the fusion spliced portion may be tapered to be made thinner, and then, the GI optical fiber is cut into the predetermined length so as to function as a convergence type rod lens having a desired property.

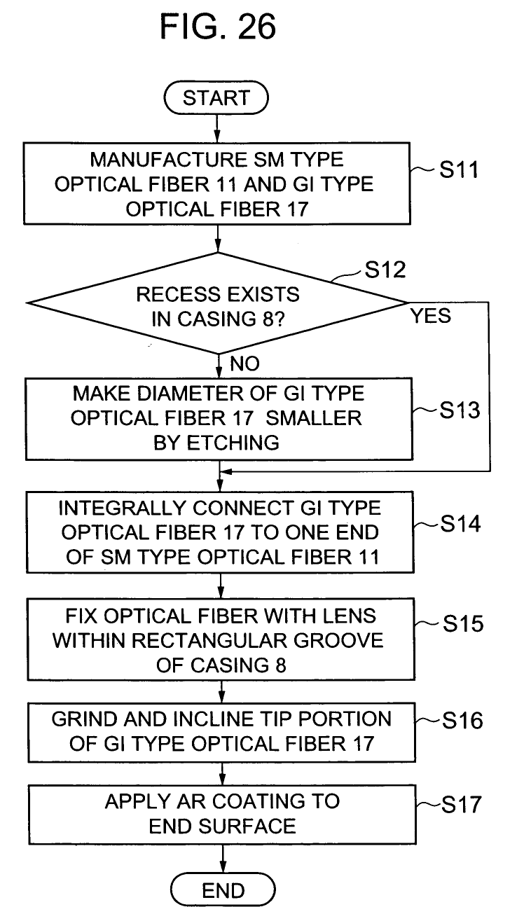

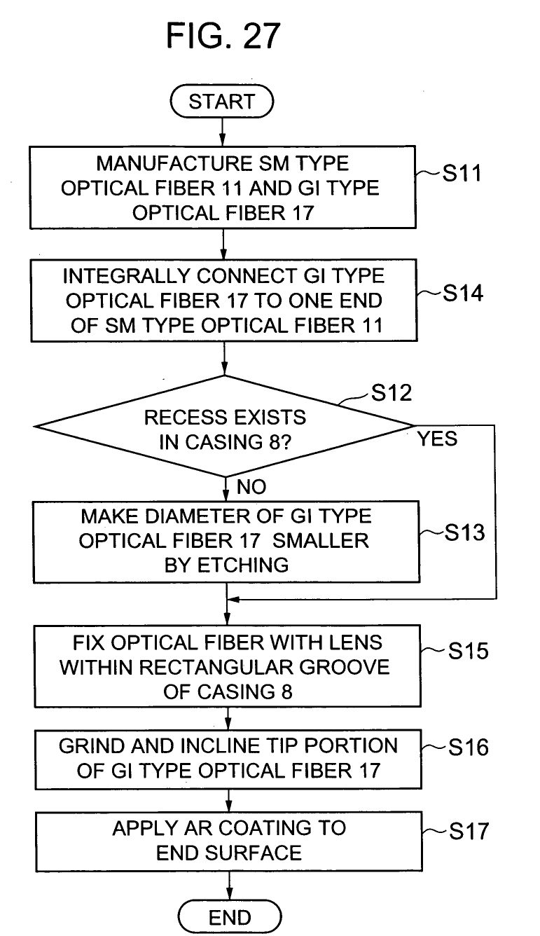

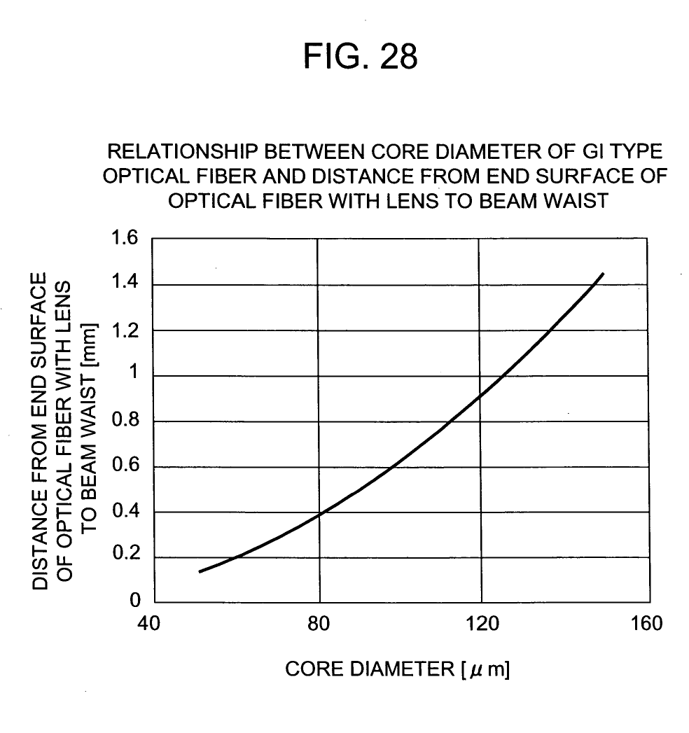

FIGS. 26 and 27 show flowcharts showing actual manufacturing methods. In the manufacturing method shown in FIG. 26, first, the SM optical fiber 11 and the GI optical fiber 17 are respectively manufactured (step S11). Note that the GI optical fiber 17 is made to have a construction having no clad part but the core part only by using either method described above. Then, the form of the casing 8 for fixing the optical fibers 6 and 7 with lens is checked. That is, in the example shown in FIG. 26, whether the recess for providing clearance for the protruding portion 12 exists in the casing 8 is checked (step S12), and in the case where the recess does not exist, etching is performed so that the GI optical fiber 17 may have a smaller diameter than the SM optical fiber 11 (step S13), as shown in FIG. 22. Assuming the case where the recess for providing clearance for the protruding portion 12 exists in the casing 8, since the thick protruding portion can be accommodated within the recess as shown in FIGS. 29 and 30 and described later, the diameter of the GI optical fiber 17 is not necessarily made smaller by etching. Then, GI optical fiber 17 is integrally connected to one end of the SM optical fiber 11 (step S14). Thus, nearly completed optical fibers 6 and 7 with lens are fixed within the rectangular groove, which is not shown, of the casing 8 (step S15), and then, the tip portions of the optical fibers 6 and 7 with lens, i.e., the tip portions of the GI optical fiber 17 are grinded to be inclined (step S16), and anti-reflection coating (AR coating) is applied to the end surface thereof (step S17). By the way, the end surface of the lens type optical fiber that has been grinded or cut to be inclined and applied with anti-reflection coating in advance may be fixed within the rectangular grooves, and thereby the steps S15, S16, and S17 may not be necessarily operated in such sequence.

On the other hand, in the manufacturing method shown in FIG. 27, first the SM optical fiber 11 and the GI optical fiber 17 are respectively manufactured (step S11) The GI optical fiber 17 is made to have construction having no clad part but the core part only by using either method described above. Then, the GI optical fiber 17 is integrally connected to one end of the SM optical fiber 11 (step S14). Subsequently, whether the recess exists in the casing 8 for fixing the optical fibers 6 and 7 with lens is checked (step S12), and in the case where the recess does not exist, etching is performed so that the GI optical fiber 17 may have a smaller diameter than the SM optical fiber 11 (step S13), as shown in FIG. 22. In this case, it is possible that the diameter of the SM optical fiber 11 is also slightly etched and made smaller in the fusion spliced portion. In the case where the recess exists in the casing 8, the diameter of the GI optical fiber 17 is not necessarily made smaller by etching. Thus, nearly completed optical fibers 6 and 7 with lens are fixed within the rectangular groove, which is not shown, of the casing 8 (step S15), and then, the tip portions of the GI optical fiber 13 are grinded to be inclined (step S16), anti-reflection coating (AR coating) is applied to the end surface (step S17). By the way, the end surface of the lens type optical fiber that has been grinded or cut to be inclined and applied with anti-reflection coating in advance may be fixed within the rectangular grooves, and thereby the steps S15, S16, and S17 may not be necessarily operated in such sequence.

As methods for integrally connecting the SM optical fiber 11 and GI optical fiber 17, a method by fusion splicing and a method by using an adhesive agent are conceivable. In the case of the optical fiber with quartz as a main component, fusion splicing is effective, while, in the case of the optical fiber with synthetic resin as a main component, bonding is effective, and specifically, preferable by using an ultraviolet curing adhesive agent (UV adhesive agent) including a refractive index matching agent.

Here, the refractive index distribution constant √A of the optical fibers 6 and 7 with lens will be considered. Note that the refractive index distribution constant √A=(2Δₙ/r²)^{1/2}=√(2Δₙ)/r, r is radius of the core part, and Δn is relative refractive index difference between the refractive index of the core part of the optical fiber and the refractive index of the part adjacent to the core part and expressed by Eq. 1.

The maximum refractive index of the core part is no, and the refractive index of the part adjacent to the core part is n₁.

FIG. 8 shows the relationship between the refractive index distribution constant √A of the GI optical fiber and the diameter D of the light beam propagation region. According to this, it is seen that, when the refractive index distribution constant √A is smaller than 1, the diameter D of the light beam propagation region becomes significantly large. In the case where the diameter D of the light beam propagation region is larger than the outer diameter of the core part that is the region where the light beam progresses in the GI optical fiber, the light leaks to the outside and the loss becomes larger. Therefore, it is preferred that the refractive index distribution constant √A is equal to or larger than 1.

Specifically, in the case of the GI optical fiber constituted only by the core part and having a diameter on the order of 125 μm as in the second embodiment, the refractive index distribution constant √A may be about 1, however, in the case of the GI optical fiber having a smaller diameter, it is preferable that the refractive index distribution constant √A is larger in response to that diameter. Further, in the case of the GI optical fiber having the clad part, it is preferred that the refractive index distribution constant √A is set so that the diameter D of the light beam propagation region may be smaller than the diameter of the core part thereof. In this case, it is possible that the diameter of the GI optical fiber is smaller than that of the SM optical fiber as in the first embodiment, or larger than or equal to that of the SM optical fiber, however, the construction in which the core part surrounded by the clad part is by far larger than 125 μm is not very practical because the outer diameter of the entire GI optical fiber becomes extremely upsized. Consequently, it is preferable that the refractive index distribution constant √A is equal to or more than 1 in relation to any GI optical fiber that is integrally connected to the optical fiber such as SM optical fiber.

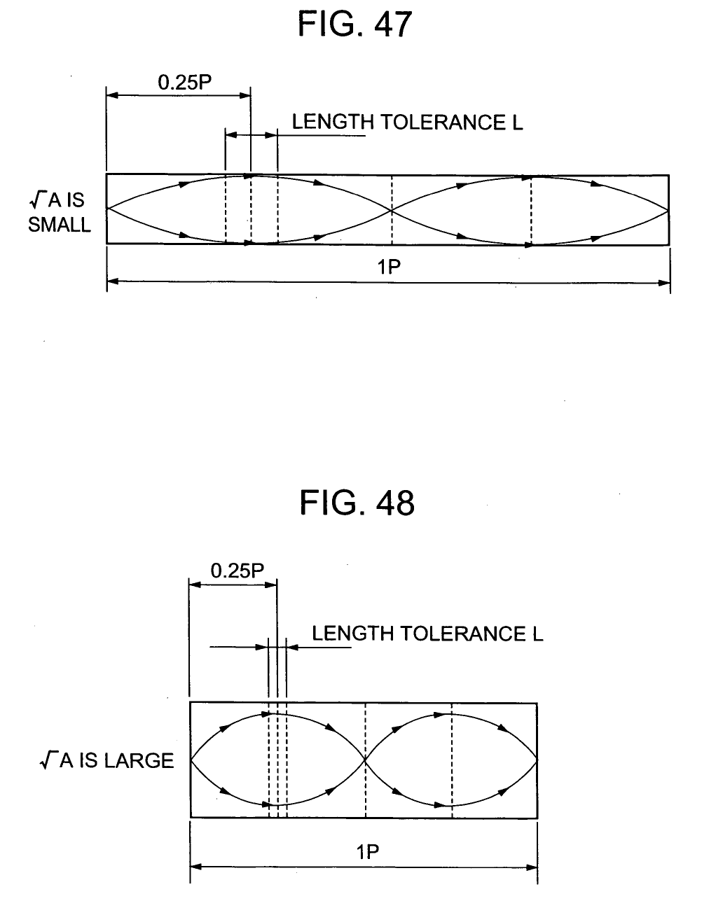

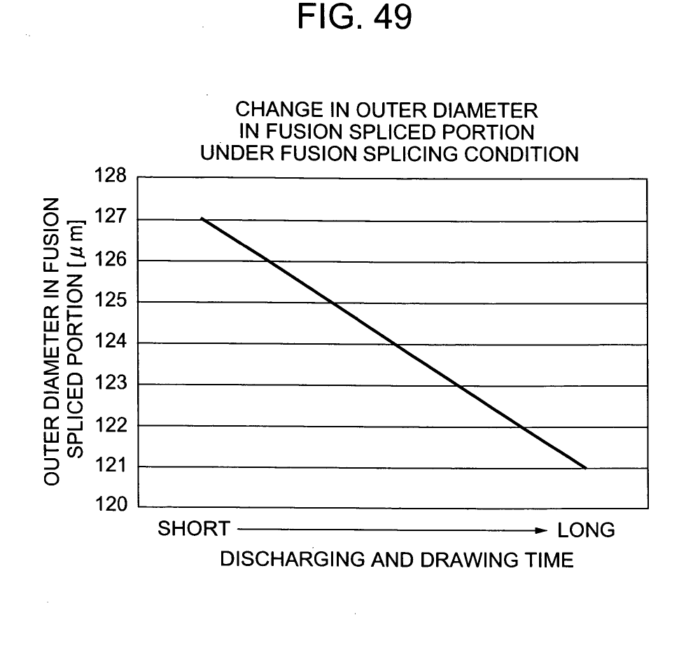

On the other hand, it is not preferred that the refractive index distribution constant √A is too large. One reason for that is that, when the refractive index distribution constant √A is large, the influence of aberration becomes larger and the distance from the end surface of the optical fiber with lens to the beam waist becomes shorter, and thereby, for example, in the case where the optical fibers with lens are opposed and an optical functional component is used by being inserted between them, the space becomes too small to insert the optical functional component. Further, another reason is that the light propagating within the GI optical fiber progresses along a sine curve, however, the larger the refractive index distribution constant √A, the steeper the light propagating within the GI optical fiber curves and the shorter the pitch of the sine curve becomes. This is shown in FIGS. 47 and 48. In the case where the collimated light beam is to be output from the GI optical fiber, the length of the GI optical fiber must be set to ¼ of the pitch (0.25P) of the sine curve or odd number times thereof to make the amplitude of the sine curve maximum, however, as described above, since the larger the refractive index distribution constant √A, the shorter the pitch of the sine curve and the steeper the sine curve, the length tolerance of the GI optical fiber having larger √A relative to the GI optical fiber having smaller √A is exacting, and the influence on the light beam becomes large even when there is only a slight error. Specifically, in the case where the refractive index distribution constant √A is larger than 4, since it is necessary to control the length of the GI optical fiber on the order of several micrometers for outputting the desired collimated light beam, putting that into practice is difficult. By the way, the preferable setting of the refractive index distribution constant √A to equal to or less than 4 can be generally applicable to the case of the GI optical fiber constituted only by the core part as in the second embodiment, the case of the GI optical fiber having the clad part and a smaller diameter than the SM optical fiber as in the first embodiment, and the case of the GI type fiber having a larger diameter than or equal diameter to the SM optical fiber.

As described above, in the optical fiber with lens of the invention, it is preferred that the refractive index distribution constant √A is from 1 to 4.

In addition, the above described pitch of the sine curve drawn by the light beam will be additionally described. This pitch P is P=2π/√A. Since the light beam propagates within the GI optical fiber while drawing the sine curve, the condition for outputting the collimated light beam is that the length of the GI optical fiber is 0.25P or odd number times thereof. Generally, in order to minimize the influence of aberration, the length of the GI optical fiber is set to 0.25P. When the length of the GI optical fiber is shorter than 0.25P, the construction for outputting diverging light is provided, while, when the length of the GI optical fiber is longer than 0.25P, the construction for outputting condensed light is provided. In the description above, the case of outputting the collimated light beam is described, however, in the case where there is an extremely small optical functional component within the optical path, the construction for condensing light may be provided by making the length of the GI optical fiber equal to or more than 0.25P and less than 0.5P, so that the beam may have a diameter according to the size of the extremely small optical functional component that is formed by using MEMS (Micro Electro Mechanical System) technology, for example. In this case, the length of the GI optical fiber is set longer than 0.25P (or odd number times thereof) by a predetermined amount, however, even in the case, it is preferred that the refractive index distribution constant √A is equal to or less than 4 because the smaller √A, the more exacting the length tolerance of the GI optical fiber becomes as well as the case of the collimated light described above. By the way, it is highly unlikely that the construction in which the diverging light is output from the GI optical fiber is realistically implemented.

Examples of constructing the optical functional component by using the optical fibers with lens in the respective embodiments described above will be described as below.

First, an aligning method for incorporating an optical fiber 20 with lens having an GI optical fiber 20b having no clad part into the optical functional component will be described. FIG. 29 shows the aligning method in the case where a locally thick protruding portion 20c when fusion splicing is produced by integrally connecting an SM optical fiber 20a and the GI optical fiber 20b having the same diameter as well as in the construction shown in FIGS. 9 and 19.

In the construction shown in FIG. 29, on an optical bench 18 that is a supporting body for aligning and fixing a number of optical fibers 20 with lens, rectangular grooves for holding the number of optical fibers are provided, and recesses 18a for accommodating the protruding portions 20c are provided in the rectangular grooves. In an optical fiber presser 19 for sandwiching the optical fibers 20 with lens by being fixed to the optical bench 18, recesses 19a opposing to the recesses 18a are also provided. The protruding portions 20c can be provided with clearance by these recesses 18a and 19a, and an array in which a desired aligned state of the optical fibers 20 with lens can be obtained is constructed. The recesses 18a and 19a have construction in which single recesses 18a and 19a may be provided across plural rectangular grooves, while a number of recesses may be provided corresponding to a number of rectangular grooves, respectively.

FIG. 30 shows an opposed optical fiber collimator that is an optical functional component fabricated by applying such construction. This opposed optical fiber collimator has a construction in which a pair of optical fibers 20 with lens opposed to each other are disposed between the optical bench 18 and the optical fiber presser 19 having recesses 18a and 19a as well as in FIG. 29. Taking a specific example thereof, the optical bench 18 is fabricated by anisotropic etching or isotropic etching of silicon, the optical fiber presser 19 is fabricated with heat-resistant glass (for example, Pyrex (registered trademark) grass), and the recesses 18a and 19a are formed by dicing etc. The construction is that the optical fibers 20 with lens having construction, in which the GI optical fiber 20b that is constituted by a core part and has an outer diameter of 80 μm and the refractive index distribution constant √A of 1.9 is fusion spliced with the SM optical fiber 11, are opposed at a distance between end surfaces of 2.4 mm, and fixed within the rectangular grooves by using ultraviolet curing resin. Then, the end surfaces of the GI optical fibers 20b opposed to each other are flat grinded and applied with anti-reflection coating (AR coating) having reflectance equal to or less than 0.5%. As a result, evaluating an optical property, the insertion loss is equal to or less than 0.3 dB.

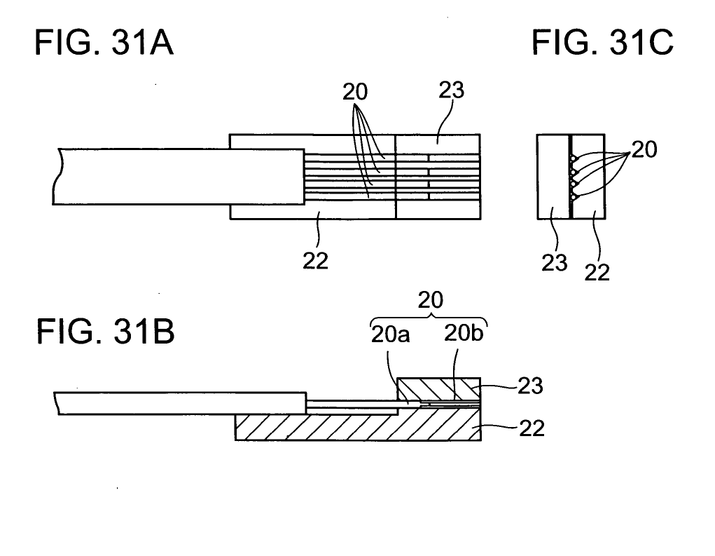

FIG. 31 shows an aligning method in the case where the SM optical fiber 20a and the GI optical fiber 20b having a thinner diameter are integrally connected as shown in FIGS. 10 and 22. This construction is an array formed by fusion splicing the GI optical fiber 20b and the SM optical fiber 20a, then performing etching with hydrofluoric acid, and aligning a number of optical fibers 20 with lens in which the GI optical fibers 20b and the portions neighboring the fusion spliced portions are made thinner by several micrometers.

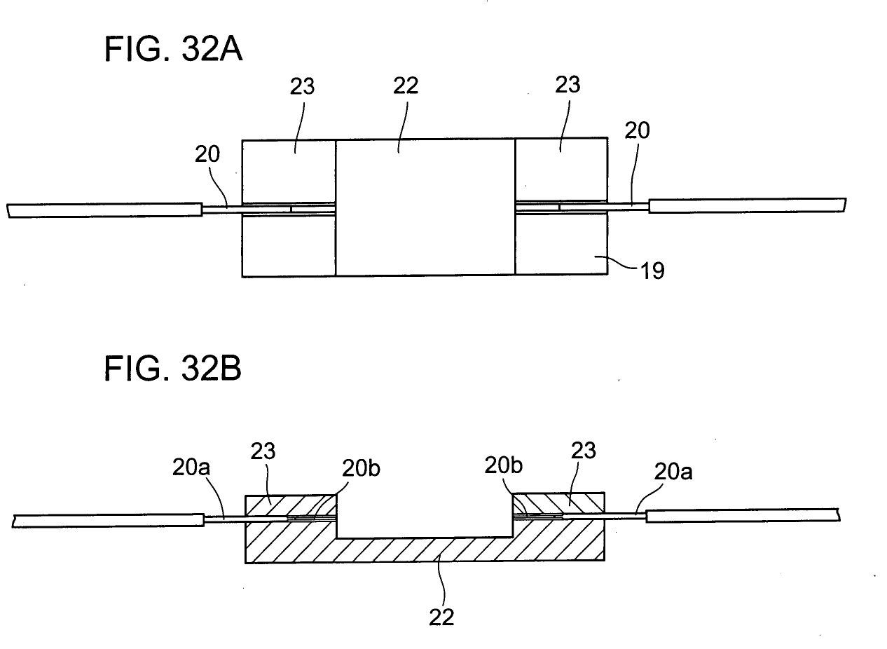

FIG. 32 shows an opposed optical fiber collimator that is an optical functional component having a pair of the optical fibers 20 with lens in which the GI optical fibers 20b and the portions neighboring the fusion spliced portions are similarly made thinner by several micrometers. In the construction, since the GI optical fiber 20b has a smaller diameter than the SM optical fiber 20a, even by the optical bench 22 and the optical fiber presser 23 without recesses as shown in FIGS. 29 and 30, the optical fibers 20 with lens are stably aligned within the rectangular grooves. By the way, in the examples shown in FIGS. 31 and 32, by drawing the GI optical fiber 20b relative to the SM optical fiber 20a during fusion splicing, not only the GI optical fiber 20b but also very slight part (fusion spliced part) of the SM optical fiber 20a is also made thinner.

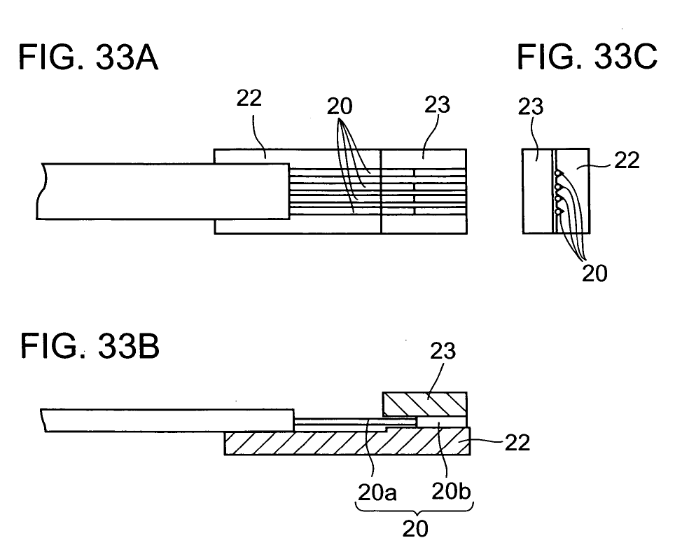

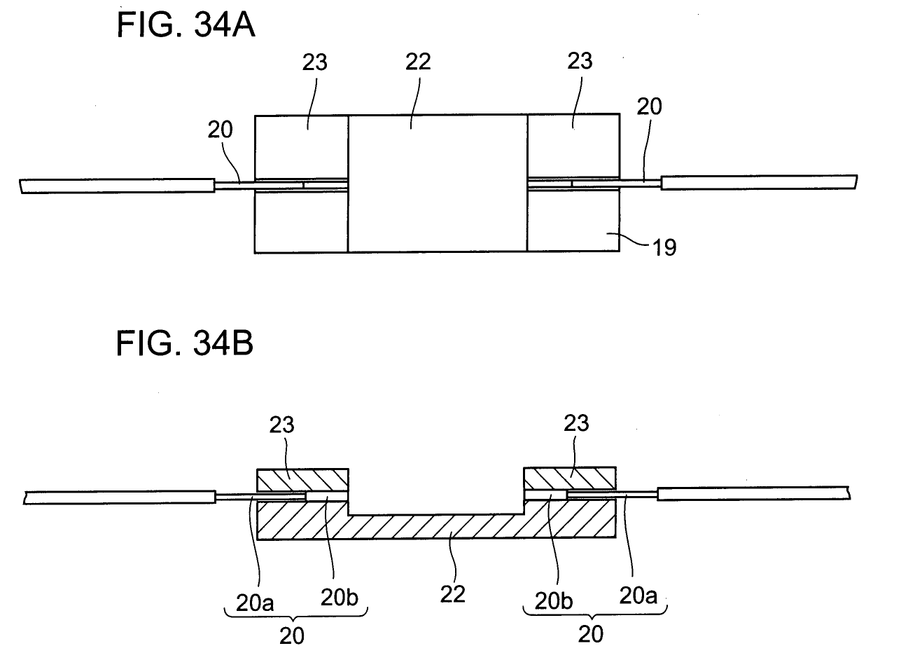

FIG. 33 shows an array in which plural optical fibers 20 with lens constituted by the SM optical fiber 20a and the GI optical fiber 20b having a larger diameter being integrally connected are aligned, and FIG. 34 shows an opposed optical fiber collimator that is an optical functional component having a pair of the optical fibers 20 with lens. In these constructions, the GI optical fiber 20a is fixed by being sandwiched by the optical bench 22 and the optical fiber presser 23.

Further, as shown in the description of the conventional examples, in the case where the optical fiber 20 with lens having a thick GI optical fiber 20b is held, the exit angle of light tends to become larger due to poor stability, and this cause to make the coupling loss larger in the case where the distance between the opposed optical fiber collimators. However, since the beam diameter can be made larger by using the GI optical fiber with no clad part, even when the exit angle is slightly inclined, the coupling loss due to displacement of the optical axes can be lessened.

In the respective arrays or the respective opposed optical fiber collimators described above, after fixing the optical fibers 20 with lens by the optical bench 18 and 22 and the optical fiber pressers 19 and 23, the end surfaces of the GI optical fibers 20b are grinded. Then, the variation of the exit angle is measured, and the good result as equal to or less than 0.1 degrees is obtained. By the way, the respective arrays may be constructed with single core (construction having only one optical fiber 20 with lens), and the construction in which the respective opposed optical fiber collimators are arrayed so that plural pairs of optical fibers 20 with lens are opposed to one another may be provided.

In addition, the embodiments shown in FIGS. 29 to 34 may have construction using lens type optical fibers having the conventional GI optical fibers.

Next, specific examples of optical functional components using the optical fibers 20 with lens in the above described respective embodiments will be described in detail.

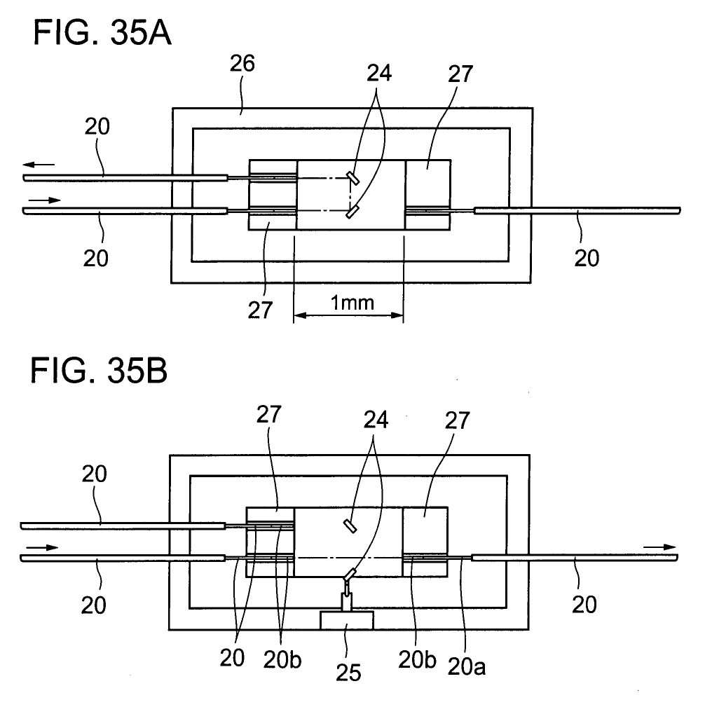

FIG. 35 shows a structure of an optical switch including optical fibers 20 with lens of the invention. This optical switch has a structure in which, within a casing 26, the optical path length is 1.0 mm, and the optical path is switchable by moving miniature mirrors 24 of deposited gold of effective dimensions of 100 μm×100 μm by an actuator 25. The construction provides different transmission paths of light beams between when one of the miniature mirrors 24 is located in the optical path of the exit side optical fiber 20 with lens as shown in FIG. 35(a) and when the miniature mirror 24 is out of the optical path by the action of the actuator 25 (omitted in FIG. 35(a)) as shown in FIG. 35(b).

The GI optical fiber 20b of the optical fiber 20 with lens used in this example has an outer diameter of 125 μm, a core diameter of 60 μm, a length of 0.6 mm, and the refractive index distribution constant √A of 2.8. Further, considering the tolerance of the mirror 24 and the optical path, the diameter of the propagating light beam is set on the order of 40 μm. The SM optical fiber 20a and the GI optical fiber 20b are integrally connected by fusion splicing. Furthermore, the end surface of the GI optical fiber 20b is grinded as inclined by 3.2 degrees, and applied with anti-reflection coating (AR coating). Note that, in order to realize the return loss equal to or more than 40 dB, it is preferred that the reflectance of the AR coating is made equal to or less than 0.5%, and the end surface angle is made from 2.0 to 4.0 degrees. This optical fiber 20 with lens is fixed on the optical bench 27 having either construction described above. Evaluating the optical property of such optical switch provides a good result that the insertion loss is equal to or less than 0.5 dB, and the return loss is equal to or more than 60 dB.

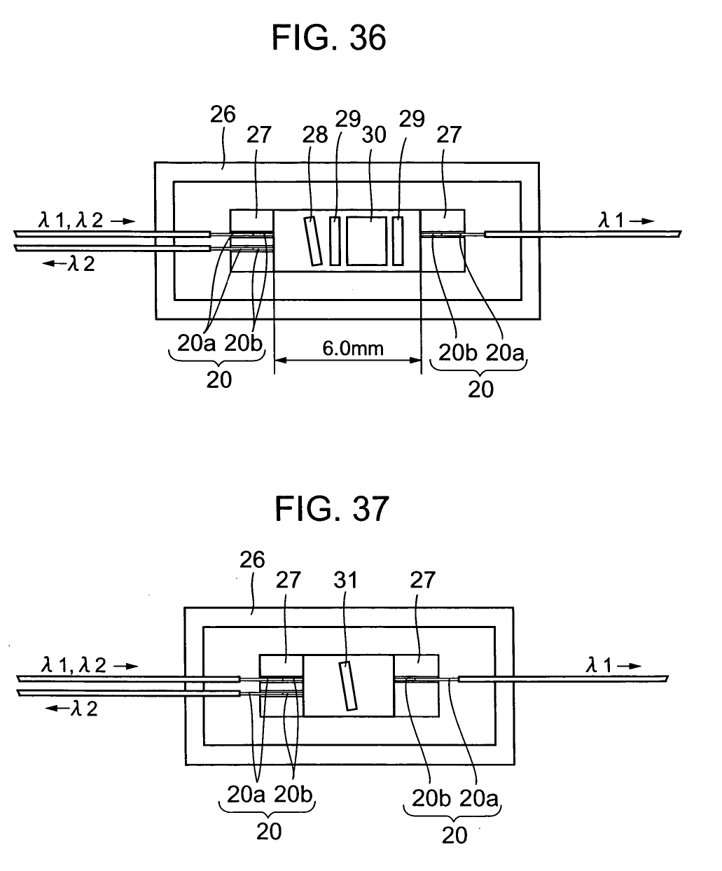

FIG. 36 shows a structure of an optical compound module including the optical fiber 20 with lens of the invention. This optical compound module has a construction in which, within a casing 26, the optical path lengths is 6.0 mm, and a wavelength filter 28, a pair of polarizers 29, and a Faraday rotator 30 located between the both polarizers 29 are disposed in the optical path, a part (λ1) of light beams (λ1, λ2) from the exit side optical fiber 20 with lens enters the opposing entrance side optical fiber 20 with lens, and the residual light beam (λ2) enters the entrance side optical fiber 20 with lens that is disposed in parallel, respectively. The GI optical fiber 20b of the respective optical fibers 20 with lens has a length of 1.4 mm, the refractive index distribution constant √A of 1.2, and is constituted only by a core part in an outer diameter of 130 μm.

FIG. 37 shows a structure of a light filter and splitter module including the optical fibers 20 with lens of the invention. This light filter and splitter module has a construction in which a wavelength filter or a half mirror 31 is disposed in the optical path within the casing 26, and a part (λ1) of light beams (λ1, λ2) from the exit side optical fiber 20 with lens enters the opposing entrance side optical fiber 20 with lens, and the residual light beam (λ2) enters the entrance side optical fiber 20 with lens that is disposed in parallel, respectively.

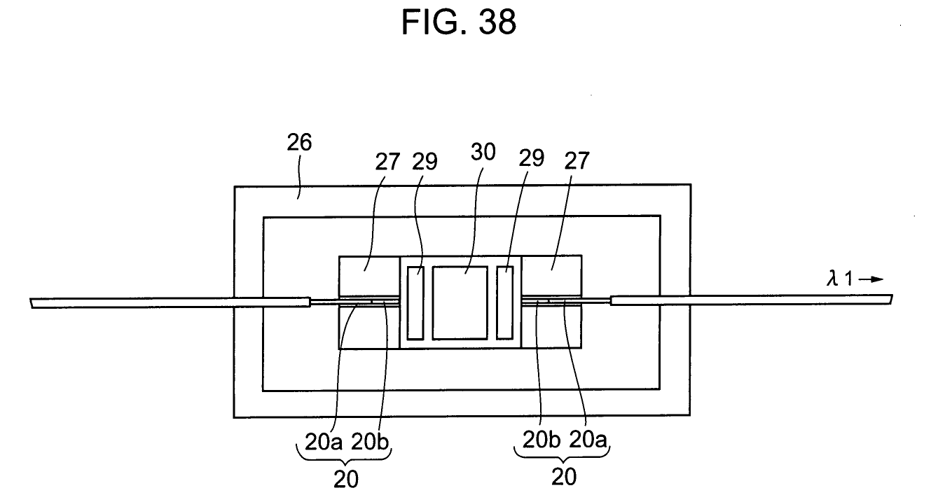

FIG. 38 shows a structure of an optical isolator including the optical fibers 20 with lens of the invention. This optical isolator has a construction in which, in the optical path within a casing 26, a pair of polarizers 29, and a Faraday rotator 30 located between the both polarizers 29 are disposed.

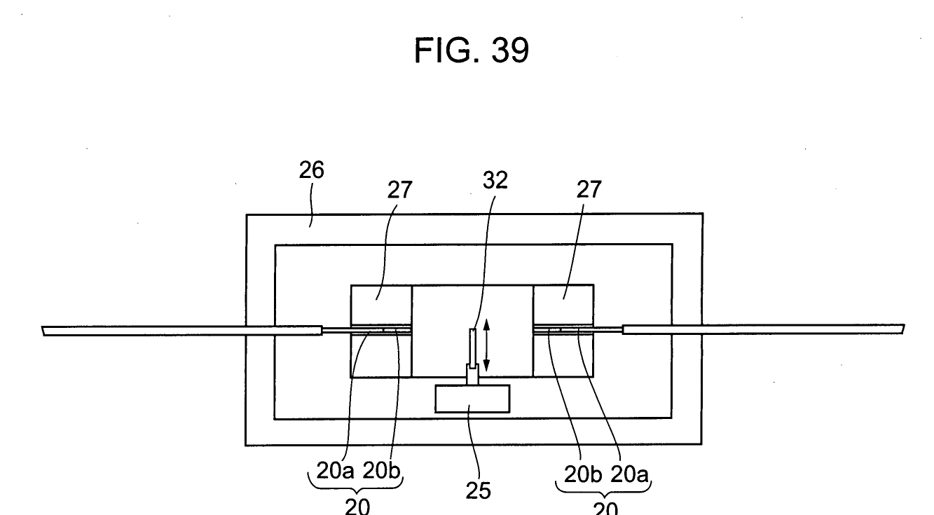

FIG. 39 shows a structure of an optical variable attenuator including the optical fibers 20 with lens of the invention. This optical variable attenuator has a construction in which the optical path is continuously shielded by moving a shielding plate 32 disposed in the optical path within a casing 26 by an actuator 25, and thereby the light beam can be variably attenuated.

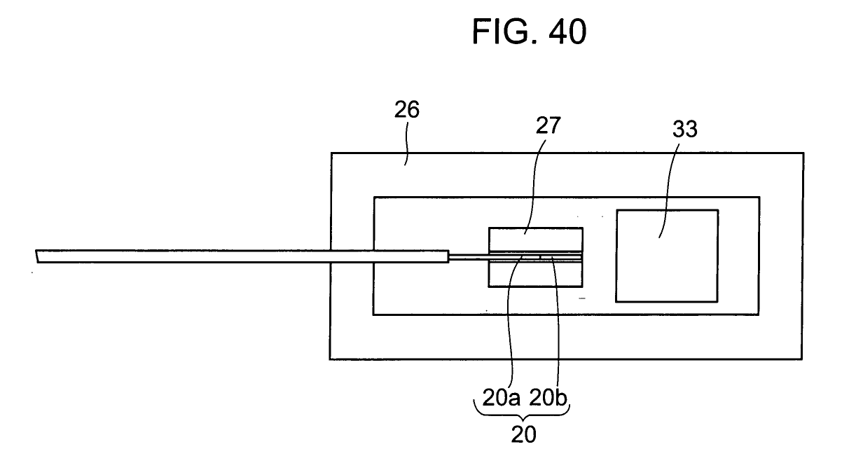

FIG. 40 shows a structure of a light receiving component including the optical fiber 20 with lens of the invention. This light receiving component has a construction in which-light can be detected by a photodiode 33 disposed in the optical path within the casing 26.

By the way, the GI optical fiber 20b of the optical fiber 20 with lens included in the respective optical functional components etc. shown in FIGS. 29 to 40 may have a construction constituted by a core part and a clad part, however, it may have a construction constituted only by a core part as well as in the second embodiment.

All of the above described embodiments have a construction in which the GI optical fiber having a lens function is integrally connected to one end of the SM optical fiber for propagating light, however, in place of the SM optical fiber, a GI optical fiber or other optical fibers can be used.

In the invention, when, to one end of the optical fiber for propagating light, a graded index optical fiber having an outer diameter equal to or smaller than an outer diameter of that optical fiber is integrally connected, since the tip portion of the optical fiber with lens becomes thin, in the case of being accommodated within a rectangular groove, the optical fiber is stably held without displacement, and thereby the complicated operation for working the rectangular groove into a complicated form is not required. Further, when aligning plural optical fibers with lens in an array, the optical fibers can be arranged in high density with small pitch, and that contributes to downsizing of the entire optical apparatus. Furthermore, since the tip portion is thin and light and the barycenter is located relatively rearward, the optical fiber can be held very stably, easy to be handled, and hardly affected by vibration.

Moreover, in the invention, when a graded index optical fiber constituted only by a core part is integrally connected to one end of the optical fiber for propagating light, since almost entire of the graded index optical fiber can be utilized as a beam propagation region, the diameter of the light beam propagation path can be enlarged to the outer diameter of the optical fiber, and thereby the influence of aberration can be suppressed, the length capable of propagation can be made longer, and the propagation efficiency can be improved.

Further, in the case where such graded index optical fiber is manufactured by drawing core part material only, there are advantages that the manufacture can be performed without wasting materials with good production efficiency, and in the case where a graded index optical fiber having the same construction as conventional is manufactured by etching to eliminate the clad part, there are advantages that exiting commercial products etc. can be used and the production efficiency can be improved.

What is claimed is:

1. An optical fiber with lens comprising: an optical fiber for propagating light and a graded index optical fiber integrally connected to one end of said optical fiber and having an outer diameter equal to or smaller than an outer diameter of said optical fiber.

2. An optical fiber with lens according to claim 1, wherein said graded index optical fiber has the outer diameter from 80 μm to 125 μm.

3. An optical fiber with lens according to claim 1, wherein said graded index optical fiber is formed so as to have the outer diameter equal to or smaller than the outer diameter of said optical fiber for propagating light by eliminating at least a part of a clad part thereof by etching.

4. An optical fiber with lens comprising: an optical fiber for propagating light and a graded index optical fiber integrally connected to one end of said optical fiber and constituted only by a core part.

5. An optical fiber with lens according to claim 4, wherein said graded index optical fiber has an outer diameter equal to or smaller than an outer diameter of said optical fiber.

6. An optical fiber with lens according to claim 4, wherein said graded index optical fiber has an outer diameter larger than an outer diameter of said optical fiber.

7. An optical fiber with lens according to claim 4, wherein said graded index optical fiber has the outer diameter from 80 μm to 130 μm.

8. An optical fiber with lens according to claim 4, wherein said graded index optical fiber is constituted only by the core part by eliminating a clad part thereof by etching.

9. An optical fiber with lens according to claim 1, wherein a refractive index distribution constant √A of said graded index optical fiber from 1.0 to 4.0.

10. An optical fiber with lens comprising: an optical fiber for propagating light and a graded index optical fiber integrally connected to one end of said optical fiber and having a refractive index distribution constant √A from 1.0 to 4.0.

11. An optical fiber with lens according to claim 1, wherein a connecting portion of said graded index optical fiber and said optical fiber is made thinner than outer diameters of these optical fibers.

12. An optical fiber with lens according to claim 1, wherein an end surface of said graded index optical fiber is inclined from 2.0 degrees to 4.0 degrees relative to a plane orthogonal to an optical axis direction.

13. An optical fiber with lens according to claim 1, wherein said optical fiber for propagating light is a single mode optical fiber.

14. An optical functional component including an optical fiber with lens according to claim 1.

15. A manufacturing method of an optical fiber with lens comprising the steps of: manufacturing a graded index optical fiber constituted only by a core part by drawing a core part material and integrally connecting said graded index optical fiber constituted only by the core part to one end of an optical fiber for propagating light.

16. A manufacturing method of an optical fiber with lens comprising the steps of: manufacturing a graded index optical fiber constituted only by a core part by etching a graded index optical fiber provided with a clad part surrounding a core part to eliminate said clad part and integrally connecting said graded index optical fiber constituted only by the core part to one end of a optical fiber for propagating light.

17. A manufacturing method of an optical fiber with lens comprising the steps of: integrally connecting a graded index optical fiber provided with a clad part surrounding a core part to one end of a optical fiber for propagating light and etching said graded index optical fiber provided with the clad part surrounding the core part to eliminate at least a part of said clad part.

18. A manufacturing method of an optical fiber with lens comprising the step of integrally connecting a graded index optical fiber having an outer diameter equal to or smaller than an outer diameter of an optical fiber for propagating light to one end of said optical fiber for propagating light.

19. A manufacturing method of an optical fiber with lens according to claim 18, further comprising the step of at least partially etching said graded index optical fiber before connected so that said graded index optical fiber may have a smaller diameter than said optical fiber.

20. A manufacturing method of an optical fiber with lens comprising the steps of: integrally connecting a graded index optical fiber having a diameter equal to or larger than that of an optical fiber for propagating light to one end of said optical fiber and at least partially etching said graded index optical fiber integrally connected to one end of said optical fiber so that said graded index optical fiber may have an outer diameter smaller than an outer diameter of said optical fiber.

21. A manufacturing method of an optical fiber with lens according to claim 15, wherein, in the manufacturing steps of said optical fiber with lens, a connecting portion of said graded index optical fiber and said optical fiber is made thinner than outer diameters of these optical fibers.

22. A manufacturing method of an optical fiber with lens according to claim 15, wherein said optical fiber for propagating light is a single mode optical fiber.

23. A manufacturing method of an optical functional component comprising the step of aligning the optical fibers with lens manufactured by the manufacturing method according to claim 15.
